(19) United States
(12) Patent Application Publication
(10) Pub. No.: US 2008/0175612 A1
(43) Pub. Date: Jul. 24, 2008

(54) Motor control device and image forming apparatus

(75) Inventors: Tatsuhiko Oikawa, Kawasaki city (JP); Toshiyuki Andoh, Sagamihana city (JP); Seiji Hoshino, Ataugi city (JP); Takashi Hodoshima, Kawasaki city (JP); Hiromichi Matsuda, Isehara city (JP); Makoto Komatsu, Naka County (JP); Takashi Hashimoto, Sagamihara city (JP); Hidetaka Noguchi, Sagamihara-city (JP); Tetsuo Watanabe, Yokohama city (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/007,513

(22) Filed: Jan. 11, 2008

(30) Foreign Application Priority Data
Jan. 18, 2007 (JP) 2007-008752
Sep. 28, 2007 (JP) 2007-256187

(51) Int. Cl. G03G 15/16

(52) U.S. Cl. 399/66

(57) ABSTRACT

A motor control device includes a pair of rotating members, a driving motor, and a timer-controller. The pair of rotating members nips and conveys a recording medium. The driving motor drives at least one rotating member of the pair of rotating members. The timer-controller calculates a time at which the recording medium passes through a nip formed by the pair of rotating members and controls the driving motor by correcting an excitation time of the driving motor near the time at which the recording medium passes through the nip formed by the pair of rotating members.

### PRIORITY STATEMENT

The present patent application claims priority from Japanese Patent Application Nos. 2007-008752, filed on Jan. 18, 2007, and 2007-256187, filed on Sep. 28, 2007, in the Japan Patent Office, the entire contents of which are hereby incorporated herein by reference.

### BACKGROUND OF THE INVENTION

1. Field of the Invention

Example embodiments generally relate to a motor control device and an image forming apparatus, for example for correcting excitation time and torque of a driving motor.

2. Description of the Related Art

A related-art image forming apparatus, such as a copier, a facsimile machine, a printer, or a multifunction printer having two or more of copying, printing, scanning, and facsimile functions, forms an image on a recording medium (e.g., a recording sheet) according to image data.

FIG. 1 illustrates one example of a related-art image forming apparatus 100R. In the image forming apparatus 100R, an optical writer (not shown) emits light beams onto charged photoconductors (not shown) according to yellow, magenta, cyan, and black image data so as to form electrostatic latent images on the photoconductors, respectively. Development devices (not shown) make visible the electrostatic latent images formed on the photoconductors with yellow, magenta, cyan, and black toner, respectively. Transfer rollers (not shown) transfer and superimpose the yellow, magenta, cyan, and black toner images formed on the photoconductors, respectively, onto an intermediate transfer belt 9R.

The intermediate transfer belt 9R is looped over a driving roller 10R, a driven roller 13R, and a second transfer counter roller 14R, and rotates in a direction of rotation I. A driving motor 12R drives the driving roller 10R at a constant speed via a reduction gear 11R. The second transfer counter roller 14R opposes a second transfer roller 15R via the intermediate transfer belt 9R, and presses the intermediate transfer belt 9R toward the second transfer roller 15R. The second transfer roller 15R transfers the yellow, magenta, cyan, and black toner images superimposed on the intermediate transfer belt 9R onto a recording sheet 18R.

The recording sheet 18R is fed from a recording sheet tray (not shown) toward a registration roller pair 16R. An insertion sensor 17R is disposed upstream from the registration roller pair 16R in a recording sheet conveyance direction, and detects the recording sheet 18R. The registration roller pair 16R feeds the recording sheet 18R between the second transfer roller 15R and the second transfer counter roller 14R. Thus, the second transfer roller 15R transfers the yellow, magenta, cyan, and black toner images (e.g., a full-color toner image) superimposed on the intermediate transfer belt 9R onto the recording sheet 18R. The recording sheet 18R bearing the full-color toner image is sent to a fixing device (not shown), and the fixing device fixes the full-color toner image on the recording sheet 18R.

In the image forming apparatus 100R having the above-described structure, image shift or color shift may occur due to fluctuation in a rotation speed of the intermediate transfer belt 9R. That is, when the yellow, magenta, cyan, and black toner images formed on the photoconductors are transferred onto the intermediate transfer belt 9R they may be misaligned to a greater or lesser extent and thus not perfectly coincidental, with the result that, when these shifted toner images are further transferred from the intermediate transfer belt 9R onto the recording sheet 18R, a faulty image is formed.

One reason for such fluctuation in the rotation speed of the intermediate transfer belt 9R is a change in a load torque applied to the intermediate transfer belt 9R caused by the recording sheet 18R entering and leaving a nip formed between the second transfer roller 15R and the second transfer counter roller 14R. That is, when a leading edge of the recording sheet 18R enters between the second transfer roller 15R and the second transfer counter roller 14R, the recording sheet 18R pushes the second transfer roller 15R and the second transfer counter roller 14R, which instantly applies a large load torque to the intermediate transfer belt 9R. Consequently, when the driving motor 12R generates a torque smaller than the load torque applied to the intermediate transfer belt 9R, the intermediate transfer belt 9R slows down.

When a trailing edge of the recording sheet 18R has passed through the nip formed between the second transfer roller 15R and the second transfer counter roller 14R, the load torque applied to the intermediate transfer belt 9R decreases sharply. Accordingly, the intermediate transfer belt 9R speeds up.

In order to prevent such fluctuation in the rotation speed of the intermediate transfer belt 9R, flywheels 30R are connected to the driving motor 12R and the driven roller 13R, respectively, to reduce sharp fluctuations in the load torque applied to the intermediate transfer belt 9R.

Specifically, the inertial moment of the flywheels 30R absorbs fluctuations in the load torque applied to the intermediate transfer belt 9R to reduce the change in the rotation speed of the intermediate transfer belt 9R. Further, the flywheels 30R may have a greater weight or diameter to further reduce the change in the rotation speed of the intermediate transfer belt 9R. Accordingly, the driving motor 12R needs to generate a greater torque to rotate the heavy, large flywheels 30R. As a result, the driving motor 12R and the flywheels 30R have a large size, increasing manufacturing costs.

In one example method for controlling the driving motor 12R and correcting the torque of the driving motor 12R as needed when the load torque applied to the intermediate transfer belt 9R changes sharply, a temporarily increased electric current is applied to the driving motor 12R to increase the torque generated by the driving motor 12R so as to prevent a transient change in the torque generated by the driving motor 12R. For example, when the load torque applied to the intermediate transfer belt 9R changes sharply, the torque of the driving motor 12R is increased or decreased to prevent fluctuation in the rotation speed of the intermediate transfer belt 9R.

In this method, however, the torque of the driving motor 12R is changed without considering the recording sheet 18R thickness, thus making fine correction difficult or impossible to perform. Moreover, additional power is consumed to increase the torque of the driving motor 12R to appropriate levels.

### SUMMARY

At least one embodiment may provide a motor control device that includes a pair of rotating members, a driving motor, and a timer-controller. The pair of rotating members nips and conveys a recording medium. The driving motor drives at least one rotating member of the pair of rotating members. The timer-controller calculates a time at which the recording medium passes through a nip formed by the pair of rotating members and controls the driving motor by correcting an excitation time of the driving motor near the time at which the recording medium passes through the nip formed by the pair of rotating members.

At least one embodiment may provide an image forming apparatus that includes an image carrier, an intermediate transfer member, a driving motor, a recording medium conveyer, a transferor, and a timer-controller. The image carrier carries a toner image. The intermediate transfer member carries the toner image transferred from the image carrier. The driving motor drives the intermediate transfer member. The recording medium conveyer conveys a recording medium. The transferor transfers the toner image carried by the intermediate transfer member onto the recording medium conveyed by the recording medium conveyer. The transferor includes a second transfer member and a counter member. The second transfer member pressingly contacts the intermediate transfer member. The counter member opposes the second transfer member via the intermediate transfer member and presses the intermediate transfer member toward the second transfer member. The timer-controller calculates a time at which the recording medium contacts the second transfer member and controls the driving motor by correcting one of an excitation time and both an excitation time and a torque of the driving motor near the time at which the recording medium contacts the second transfer member.

At least one embodiment may provide an image forming apparatus that includes an image carrier, an intermediate transfer member, a driving motor, a recording medium conveyer, a transferor, a fixing device, and a timer-controller. The image carrier carries a toner image. The intermediate transfer member carries the toner image transferred from the image carrier. The driving motor drives the intermediate transfer member. The recording medium conveyer conveys a recording medium. The transferor transfers the toner image carried by the intermediate transfer member onto the recording medium conveyed by the recording medium conveyer. The fixing device is provided downstream from the transferor in a recording medium conveyance direction to fix the toner image on the recording medium. The fixing device includes a roller pair and a fixing motor. The roller pair nips the recording medium bearing the toner image. The fixing motor drives the roller pair. The timer-controller calculates a time at which the recording medium passes through a nip formed by the roller pair and controls the fixing motor by correcting one of an excitation time and both an excitation time and a torque of the fixing motor near the time at which the recording medium passes through the nip formed by the roller pair.

Additional features and advantages of example embodiments will be more fully apparent from the following detailed description, the accompanying drawings, and the associated claims.

### BRIEF DESCRIPTION OF THE DRAWINGS

A more complete appreciation of example embodiments and the many attendant advantages thereof will be readily obtained as the same becomes better understood by reference to the following detailed description when considered in connection with the accompanying drawings, wherein:

FIG. 1 is a sectional view of a related-art image forming apparatus;

FIG. 2 is a sectional view of an image forming apparatus according to an example embodiment;

FIG. 3 is a graph (according to an example embodiment) illustrating an example change in a rotation speed of an intermediate transfer belt included in the image forming apparatus shown in FIG. 2;

FIG. 4 is a sectional view (according to an example embodiment) of the image forming apparatus shown in FIG. 2 when a leading edge of a recording sheet enters a nip formed between a second transfer roller and a second transfer counter roller included in the image forming apparatus;

FIG. 5 is a sectional view (according to an example embodiment) of the image forming apparatus shown in FIG. 4 when a trailing edge of the recording sheet leaves the nip;

FIG. 6 is a graph (according to an example embodiment) illustrating a load torque change curve converted from a speed change curve of the intermediate transfer belt illustrated in FIG. 3;

FIG. 7 is a graph (according to an example embodiment) illustrating a relationship between a thickness of a recording sheet and a speed change rate and a load torque change rate of an intermediate transfer belt included in the image forming apparatus shown in FIG. 2;

FIG. 8 is another graph (according to an example embodiment) illustrating a relationship between a thickness of a recording sheet and a speed change rate and a load torque change rate of an intermediate transfer belt included in the image forming apparatus shown in FIG. 2;

FIG. 9 is an enlarged sectional view (according to an example embodiment) of the image forming apparatus shown in FIG. 2;

FIG. 10 is a sectional view (according to an example embodiment) of one example of a thickness sensor included in the image forming apparatus shown in FIG. 9;

FIG. 11 is a sectional view (according to an example embodiment) of another example of a thickness sensor included in the image forming apparatus shown in FIG. 9;

FIG. 12 is a perspective view (according to an example embodiment) of one example of a recording sheet tray included in the image forming apparatus shown in FIG. 2;

FIG. 13 is a perspective view (according to an example embodiment) of another example of a recording sheet tray included in the image forming apparatus shown in FIG. 2;

FIG. 14 is a block diagram (according to an example embodiment) of the image forming apparatus shown in FIG. 9;

FIG. 15 is a plane view (according to an example embodiment) of a stator and a rotor of a driving motor included in the image forming apparatus shown in FIG. 9;

FIG. 16 is a graph (according to an example embodiment) illustrating a first example method for correcting an excitation time and a torque of a driving motor included in the image forming apparatus shown in FIG. 9;

FIG. 17 is a graph (according to an example embodiment) illustrating a second example method for correcting an excitation time and a torque of a driving motor included in the image forming apparatus shown in FIG. 9;

FIG. 18 is a timing chart (according to an example embodiment) of controls performed in the second example method shown in FIG. 17;

FIGS. 19A, 19B, and 19C illustrate a flowchart (according to an example embodiment) of operations performed in the second example method shown in FIG. 17;

FIG. 20 is a sectional view of an image forming apparatus according to another example embodiment;

FIG. 21 is a sectional view of an image forming apparatus according to yet another example embodiment; and

FIG. 22 is a sectional view of an image forming apparatus according to yet another example embodiment.

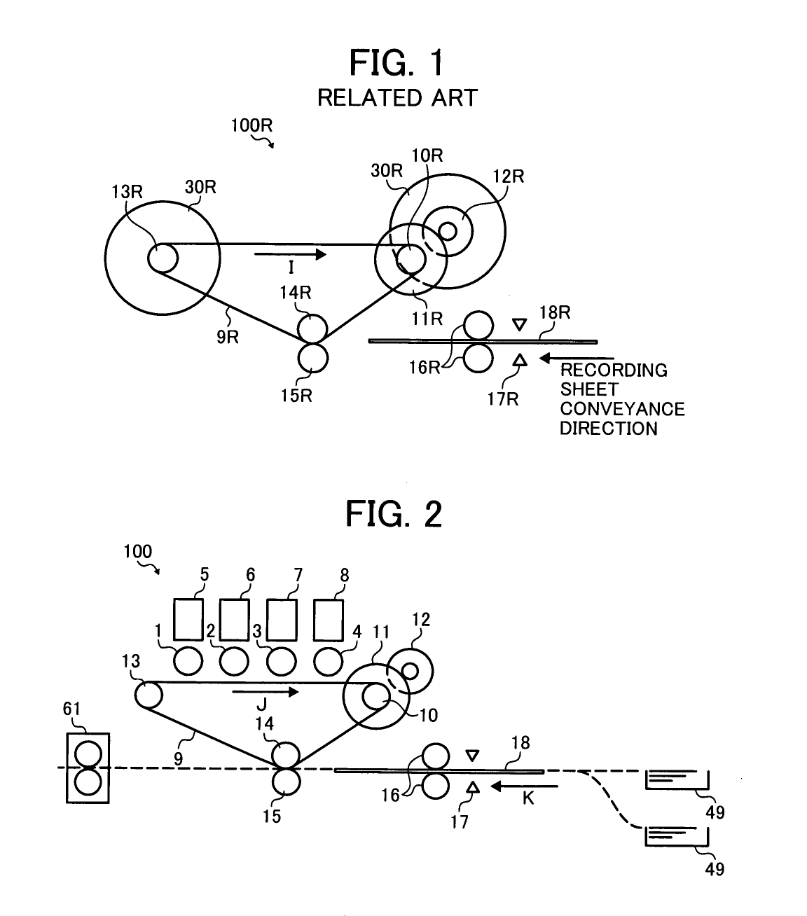

The accompanying drawings are intended to depict example embodiments and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a” “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

Referring now to the drawings, wherein like reference numerals designate identical or corresponding parts throughout the several views, particularly to FIG. 2, an image forming apparatus 100 according to an example embodiment is explained.

FIG. 2 is a sectional view of the image forming apparatus 100, and illustrates an example structure of a tandem-type color image forming apparatus. As illustrated in FIG. 2, the image forming apparatus 100 includes photoconductors 1, 2, 3, and 4, development devices 5, 6, 7, and 8, an intermediate transfer belt 9, a driving roller 10, a driven roller 13, a second transfer counter roller 14, a driving motor 12, a reduction gear 11, a second transfer roller 15, recording sheet trays 49, a registration roller pair 16, an insertion sensor 17, and/or a fixing device 61.

The image forming apparatus 100 may be a copier, a facsimile machine, a printer, a multifunction printer having two or more of copying, printing, scanning, and facsimile functions, or the like. According to this example embodiment, the image forming apparatus 100 functions as a color printer for forming a color image by superimposing yellow, magenta, cyan, and black toner images.

The photoconductors 1, 2, 3, and 4 (e.g., photoconductive drums) serve as independent image carriers and are rotated by a driving motor (not shown). Chargers (not shown) uniformly charge the photoconductors 1, 2, 3, and 4, respectively. An optical writing unit (not shown), serving as an exposure device, emits light beams onto the photoconductors 1, 2, 3, and 4 according to yellow, magenta, cyan, and black image data so as to form electrostatic latent images on the photoconductors 1, 2, 3, and 4, respectively.

The development devices 5, 6, 7, and 8 visualize the electrostatic latent images formed on the photoconductors 1, 2, 3, and 4 with yellow, magenta, cyan, and black toner, respectively. For example, the electrostatic latent images electrostatically attract the yellow, magenta, cyan, and black toner to form yellow, magenta, cyan, and black toner images on the photoconductors 1, 2, 3, and 4, respectively. Transfer rollers (not shown) transfer and superimpose the yellow, magenta, cyan, and black toner images formed on the photoconductors 1, 2, 3, and 4, respectively, onto the intermediate transfer belt 9 serving as an intermediate transfer member, so as to form a full-color toner image on the intermediate transfer belt 9.

The intermediate transfer belt 9 also serves as an image carrier for carrying the full-color toner image. The intermediate transfer belt 9 is looped over the driving roller 10, the driven roller 13, and the second transfer counter roller 14, and rotates in a direction of rotation J. The driving motor 12 drives the driving roller 10 at a constant speed via the reduction gear 11. A driving motor other than the driving motor 12 may drive the photoconductors 1, 2, 3, and 4. Alternatively, the driving motor 12 may drive the photoconductors 1, 2, 3, and 4 and the intermediate transfer belt 9. A power supply (not shown) applies a transfer bias to the second transfer roller 15 serving as a second transfer member. The second transfer counter roller 14 serves as a counter member for opposing the second transfer roller 15 via the intermediate transfer belt 9. The second transfer roller 15 and the second transfer counter roller 14 serve as a transferor. The second transfer counter roller 14 presses the intermediate transfer belt 9 toward the second transfer roller 15. The second transfer roller 15 transfers the full-color toner image formed on the intermediate transfer belt 9 onto a recording sheet 18 serving as a recording medium and not limited to paper.

A plurality of recording sheet trays 49 serves as a recording medium container for containing recording sheets 18. A recording sheet 18 is fed from one of the recording sheet trays 49 selected toward the registration roller pair 16 serving as a recording medium conveyer. The registration roller pair 16 regulates a leading edge of the recording sheet 18. The insertion sensor 17 is disposed upstream from the registration roller pair 16 in a recording sheet conveyance direction K, and detects the recording sheet 18 on a recording sheet conveyance path provided upstream from the registration roller pair 16 in the recording sheet conveyance direction K. The registration roller pair 16 starts rotating in accordance with a command to feed the recording sheet 18 to the second transfer roller 15. When the recording sheet 18 passes through a nip formed between the second transfer roller 15 and the second transfer counter roller 14, the second transfer roller 15 transfers the yellow, magenta, cyan, and black toner images (e.g., the full-color toner image) superimposed on the intermediate transfer belt 9 onto the recording sheet 18. The recording sheet 18 bearing the full-color toner image is sent to the fixing device 61. The fixing device 61 fixes the full-color toner image on the recording sheet 18 by applying heat to the recording sheet 18.

In the image forming apparatus 100 having the above-described structure, image shift or color shift may occur due to a change (e.g., fluctuation) in a rotation speed of the intermediate transfer belt 9. For example, the yellow, magenta, cyan, and black toner images formed on the photoconductors 1, 2, 3, and 4, respectively, are transferred onto the intermediate transfer belt 9 in a state in which the yellow, magenta, cyan, and black toner images are shifted from each other. To prevent the image shift or the color shift, a transfer position on the intermediate transfer belt 9, at which the yellow, magenta, cyan, and black toner images are transferred, need to be adjusted by calculating transfer times based on distances among the photoconductors 1, 2, 3, and 4 and rotation speeds of the photoconductors 1, 2, 3, and 4 and the intermediate transfer belt 9. Moreover, the rotation speeds of the photoconductors 1, 2, 3, and 4 and the intermediate transfer belt 9 need to be constant.

The yellow, magenta, cyan, and black toner images formed on the rotating photoconductors 1, 2, 3, and 4, respectively, are transferred onto the rotating intermediate transfer belt 9 so that the yellow, magenta, cyan, and black toner images are superimposed on a common position on the intermediate transfer belt 9 to form a full-color toner image. However, a distance is provided between each of the adjacent photoconductors (e.g., the photoconductors 1 and 2, the photoconductors 2 and 3, and the photoconductors 3 and 4). Therefore, different portions of an image are simultaneously transferred from the photoconductors 1, 2, 3, and 4 onto the intermediate transfer belt 9. When the rotation speed of the intermediate transfer belt 9 changes, the yellow, magenta, cyan, and black toner images are not superimposed on the common position on the intermediate transfer belt 9 and are transferred on positions shifted from each other on the intermediate transfer belt 9, resulting in image shift or color shift. When the shifted toner images are further transferred from the intermediate transfer belt 9 onto a recording sheet 18, a faulty image is formed on the recording sheet 18.

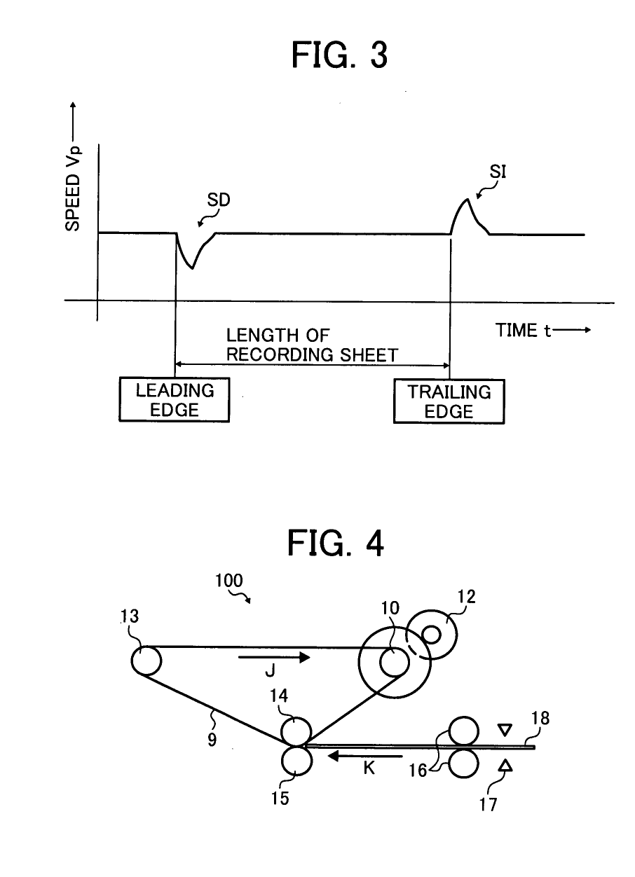

FIG. 3 is a graph illustrating an example change in the rotation speed of the intermediate transfer belt 9 (depicted in FIG. 2). In FIG. 3, a horizontal axis represents a time t and a vertical axis represents a speed Vp of the intermediate transfer belt 9. A speed decrease SD represents a moment when a leading edge of a recording sheet 18 enters the nip formed between the second transfer roller 15 and the second transfer counter roller 14 as illustrated in FIG. 4. For example, when the recording sheet 18 pushes the second transfer roller 15 and the second transfer counter roller 14, the speed Vp slows down. A force of the recording sheet 18 for pushing the second transfer roller 15 and the second transfer counter roller 14 instantly applies a great load torque to the intermediate transfer belt 9. Accordingly, the driving motor 12 needs to generate a great torque instantly. When the driving motor 12 generates a torque smaller than the load torque applied to the intermediate transfer belt 9, the speed Vp of the intermediate transfer belt 9 decreases.

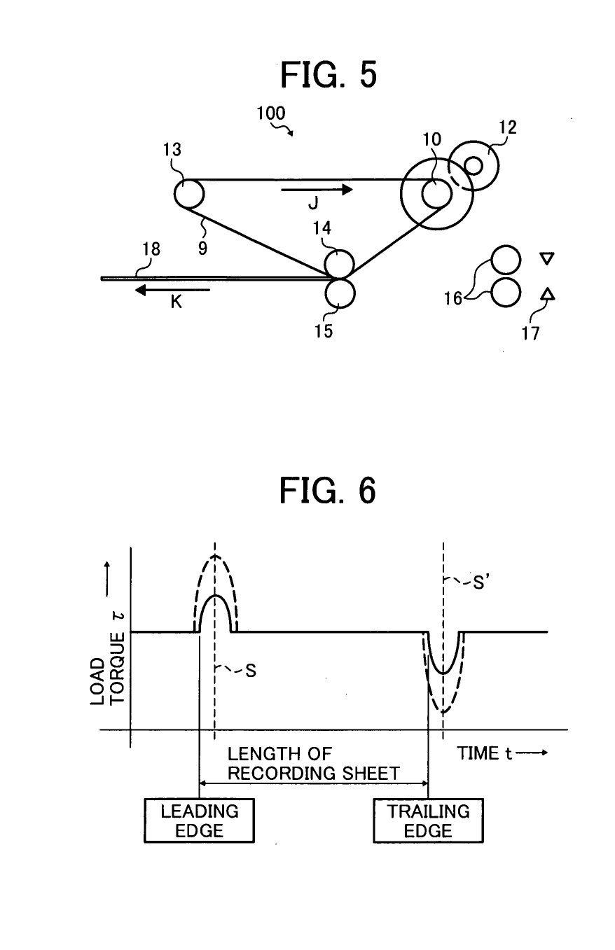

When the recording sheet 18 is thick, a great load torque is instantly applied to the intermediate transfer belt 9. When a trailing edge of the recording sheet 18 has passed through the nip formed between the second transfer roller 15 and the second transfer counter roller 14 as illustrated in FIG. 5, the load torque applied to the intermediate transfer belt 9 decreases sharply. Accordingly, a load applied to the driving motor 12 also decreases sharply. Thus, the speed Vp of the intermediate transfer belt 9 increases as indicated by a speed increase SI in FIG. 3.

FIG. 6 is a graph illustrating a load torque change curve converted from a speed change curve (e.g., a characteristic curve) of the intermediate transfer belt 9 illustrated in FIG. 3. In FIG. 6, a solid-line curve represents a load torque change when a thin recording sheet 18 is used and a broken-line curve represents a load torque change when a thick recording sheet 18 is used.

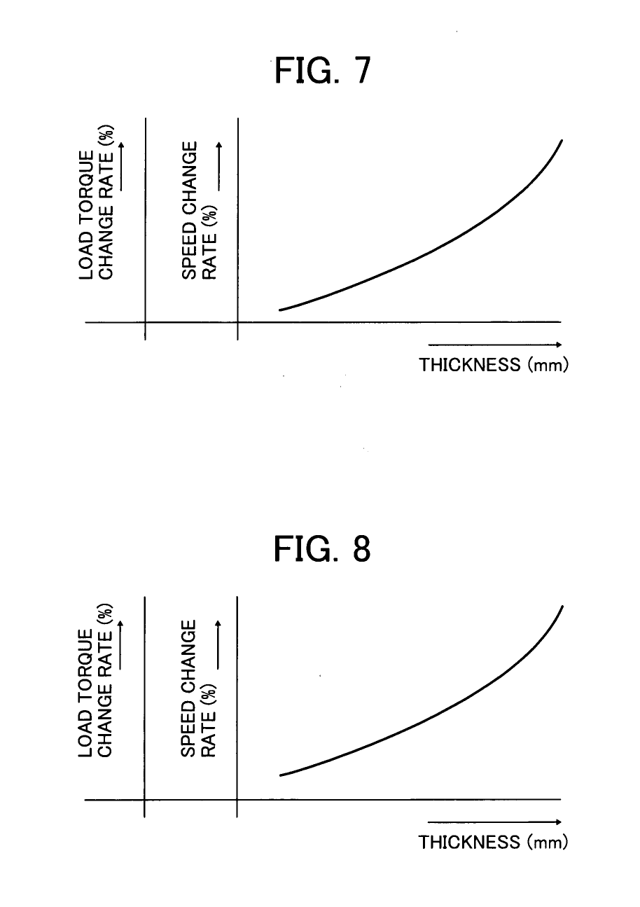

FIG. 7 is a graph illustrating a speed change rate and a load torque change rate of the intermediate transfer belt 9 (depicted in FIG. 2) which vary depending on a thickness of a recording sheet 18, when the leading edge of the recording sheet 18 enters the nip formed between the second transfer roller 15 and the second transfer counter roller 14 (depicted in FIG. 2).

FIG. 8 is a graph illustrating a speed change rate and a load torque change rate of the intermediate transfer belt 9 (depicted in FIG. 2) which vary depending on a thickness of a recording sheet 18, when the trailing edge of the recording sheet 18 leaves the nip formed between the second transfer roller 15 and the second transfer counter roller 14 (depicted in FIG. 2). The thicker the recording sheet 18 is, the greater the speed change rate and the load torque change rate become.

The driving motor 12 (depicted in FIG. 2) may control the speed Vp of the intermediate transfer belt 9 when the load applied to the driving motor 12 gradually changes. However, the driving motor 12 may not control the speed Vp of the intermediate transfer belt 9 quickly when the load changes substantially and sharply. For example, the driving motor 12 may not cope with a sharp change of load which generates when the leading edge of the recording sheet 18 enters the nip formed between the second transfer roller 15 and the second transfer counter roller 14 and when the trailing edge of the recording sheet 18 leaves the nip. Thus, the speed Vp of the intermediate transfer belt 9 changes. As a result, the yellow, magenta, cyan, and black toner images formed on the photoconductors 1, 2, 3, and 4, respectively, are not properly superimposed on the intermediate transfer belt 9, causing image shift or color shift.

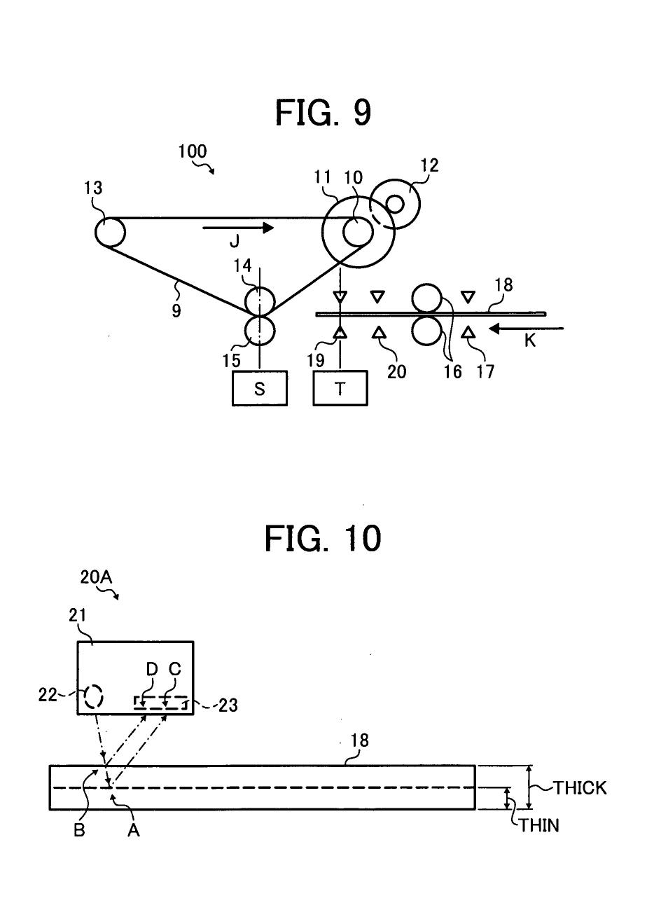

FIG. 9 is an enlarged sectional view of the image forming apparatus 100. As illustrated in FIG. 9, the image forming apparatus 100 further includes a thickness sensor 20 and/or a recording sheet sensor 19.

The thickness sensor 20, serving as a thickness detector, and the recording sheet sensor 19, serving as a recording medium detector, are provided at positions between the registration roller pair 16 and the nip formed between the second transfer roller 15 and the second transfer counter roller 14, respectively. However, the thickness sensor 20 may be disposed at a position other than the position between the registration roller pair 16 and the second transfer counter roller 14.

The thickness sensor 20 detects a thickness of a recording sheet 18 fed by the registration roller pair 16 toward the nip formed between the second transfer roller 15 and the second transfer counter roller 14 on the recording sheet conveyance path. Before the recording sheet 18 reaches the nip formed between the second transfer roller 15 and the second transfer counter roller 14, the recording sheet sensor 19 detects the recording sheet 18 on the recording sheet conveyance path.

FIG. 10 illustrates a thickness sensor 20A as an example of the thickness sensor 20 (depicted in FIG. 9). As illustrated in FIG. 10, the thickness sensor 20A includes a laser displacement gauge 21. The laser displacement gauge 21 includes a laser emitter 22 and/or a laser receiver 23. The image forming apparatus 100 (depicted in FIG. 9) may use a recording sheet 18 having a thickness of from about 0.05 mm to about 0.5 mm. The thickness of the recording sheet 18 may be directly measured by using a laser beam. For example, in the laser displacement gauge 21, the laser emitter 22 emits a laser beam onto the recording sheet 18. The recording sheet 18 reflects the laser beam emitted by the laser emitter 22 at a point A on a surface of the recording sheet 18, when the recording sheet 18 is a thin sheet. The recording sheet 18 reflects the laser beam emitted by the laser emitter 22 at a point B on the surface of the recording sheet 18, when the recording sheet 18 is a thick sheet.

The reflected laser beam enters the laser receiver 23. The laser receiver 23 includes a line-type CCD (charge-coupled device) sensor. The laser beam reflected at the point A on the recording sheet 18 enters a point C of the laser displacement gauge 21. The laser beam reflected at the point B on the recording sheet 18 enters a point D of the laser displacement gauge 21. Thus, the position at which the laser beam enters the laser displacement gauge 21 varies depending on the thickness of the recording sheet 18. Accordingly, the laser displacement gauge 21 outputs a thickness measurement signal corresponding to the position at which the laser beam enters the laser displacement gauge 21.

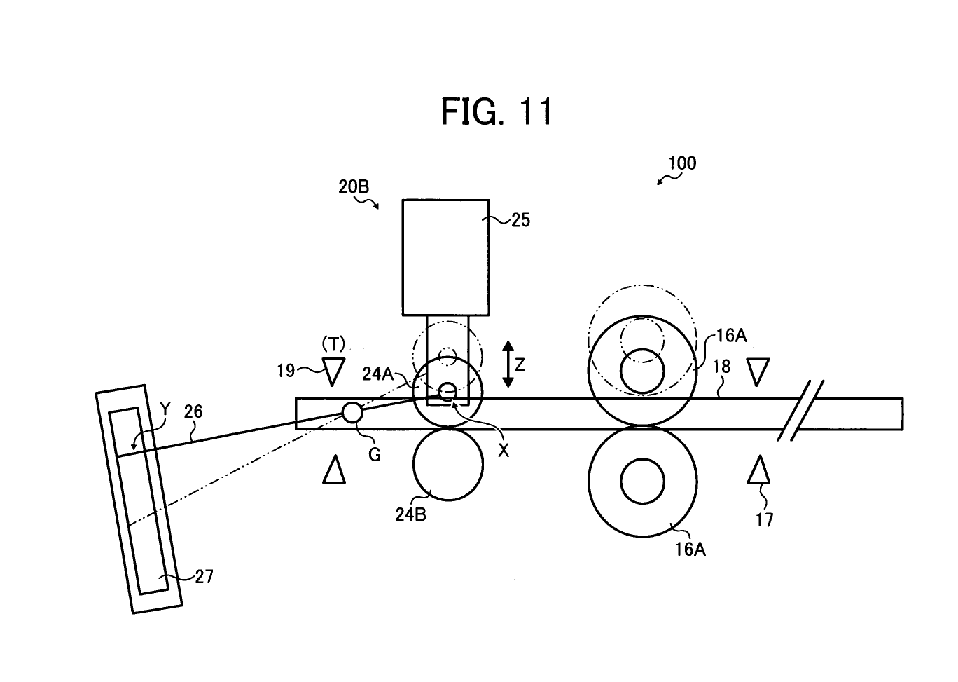

FIG. 11 illustrates a thickness sensor 20B as another example of the thickness sensor 20 (depicted in FIG. 9) for directly measuring the thickness of the recording sheet 18. FIG. 11 is a sectional view of the thickness sensor 20B. As illustrated in FIG. 11, the image forming apparatus 100 includes a registration roller pair 16A. The thickness sensor 20B includes a thickness detection roller 24A, a fixed roller 24B, a thickness detection lever 26, a CCD sensor 27, and/or a plunger magnet 25.

The registration roller pair 16A replaces the registration roller pair 16 depicted in FIG. 9. The thickness detection roller 24A and the fixed roller 24B serve as a roller pair and are provided on the recording sheet conveyance path. A support point G rotatably supports the thickness detection lever 26. One end (e.g., a point X) of the thickness detection lever 26 is rotatably attached to a center of the thickness detection roller 24A. The CCD sensor 27 (e.g., a line-type CCD sensor) is provided at another end (e.g., a point Y) of the thickness detection lever 26. The thickness detection roller 24A is supported in a manner that the thickness detection roller 24A is rotatable and movable in a direction in which the thickness detection roller 24A separates from the fixed roller 24B. The fixed roller 24B is supported in a manner that the fixed roller 24B is rotatable but not movable in a direction in which the fixed roller 24B separates from the thickness detection roller 24A. When the recording sheet 18 passes between the thickness detection roller 24A and the fixed roller 24B, the thickness detection roller 24A moves to a position illustrated in a broken line in accordance with the thickness of the recording sheet 18. Accordingly, the thickness detection lever 26 rotates to a position illustrated in a broken line. The CCD sensor 27 measures a position of the point Y of the thickness detection lever 26 so as to detect the thickness of the recording sheet 18. The recording sheet 18 has a small thickness. Therefore, a length between the point X and the support point G and a length between the support point G and the point Y may be selected to obtain a proper ratio for the CCD sensor 27 to detect the thickness of the recording sheet 18 based on a change amount (e.g., a moving amount) of the thickness detection roller 24A.

The registration roller pair 16A, which is movable, may replace the thickness detection roller 24A and the fixed roller 24B. However, when the thickness detection roller 24A is provided in addition to the registration roller pair 16A, a distance between the registration roller pair 16A and the second transfer roller 15 (depicted in FIG. 9) may be flexibly set. Further, the thickness detection lever 26 and the support point G may be flexibly positioned or laid out. The, plunger magnet 25 moves the thickness detection roller 24A in directions Z. An arithmetic device (not shown) drives the plunger magnet 25 before the recording sheet 18 is conveyed from the registration roller pair 16A to the thickness detection roller 24A, so that the thickness detection roller 24A separates from the fixed roller 24B. Accordingly, a gap is formed between the thickness detection roller 24A and the fixed roller 24B.

After a leading edge of the recording sheet 18 passes the thickness detection,roller 24A, the arithmetic device stops driving the plunger magnet 25, so that the gap is not formed between the thickness detection roller 24A and the fixed roller 24B. The CCD sensor 27 measures the position of the point Y of the thickness detection lever 26 so as to detect the thickness of the recording sheet 18. After a trailing edge of the recording sheet 18 passes the thickness detection roller 24A, the arithmetic device drives the plunger magnet 25, so that a next recording sheet 18 may be easily conveyed in the gap formed between the thickness detection roller 24A and the fixed roller 24B, preventing the next recording sheet 18 from being damaged.

The change in the load torque applied to the intermediate transfer belt 9 (depicted in FIG. 9) may vary depending on the width of the recording sheet 18 (e.g., a length of the recording sheet 18 in a direction perpendicular to the recording sheet conveyance direction K). Even when the recording sheet 18 has a constant thickness, the load torque varies depending on the width of the recording sheet 18. For example, the greater the width of the recording sheet 18 is, the greater the change in the load torque becomes. The smaller the width of the recording sheet 18 is, the smaller the change in the load torque becomes. Therefore, when amounts of corrections of an excitation time and a torque of the driving motor 12 are determined by considering the width of the recording sheet 18 in addition to the thickness of the recording sheet 18, the torque of the driving motor 12 may be properly corrected with respect to the change in the load torque.

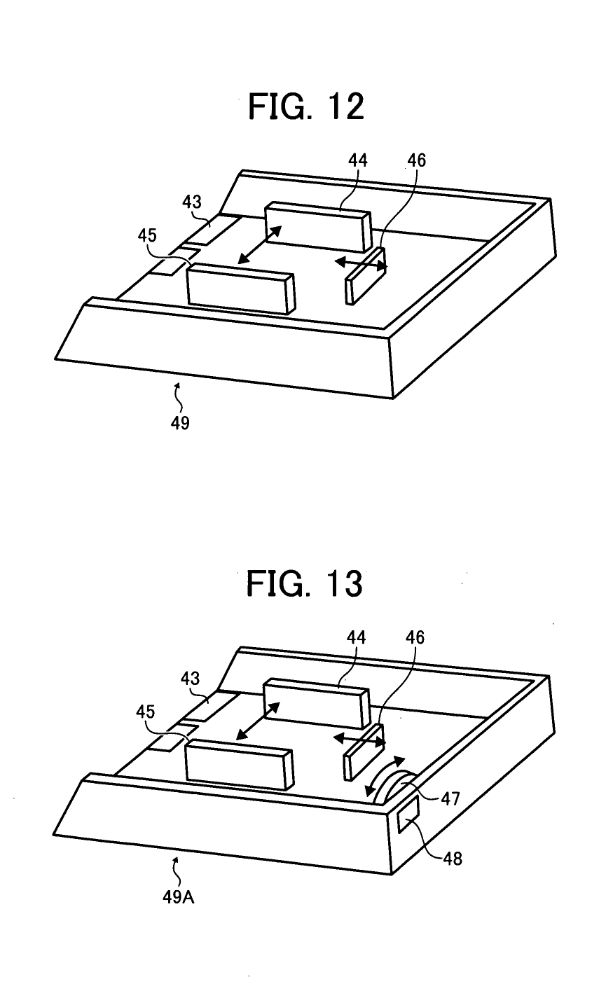

Referring to FIGS. 12 and 13, the following describes example methods for detecting the width of the recording sheet 18. FIG. 12 is a perspective view of the recording sheet tray 49. As illustrated in FIG. 12, the recording sheet tray 49 includes side plates 44 and 45, a tail plate 46, and/or a width sensor 43.

The recording sheet tray 49 contains a recording sheet 18. The side plates 44 and 45 and the tail plate 46 are provided in the recording sheet tray 49 and are movable in correspondence to a size of the recording sheet 18. For example, the side plates 44 and 45 and the tail plate 46 move to contact side and tail edges of the recording sheet 18, respectively.

The width sensor 43, serving as a width detector, is provided on a back side on one end of the recording sheet tray 49. When the side plates 44 and 45 and the tail plate 46 are moved to correspond to the width of the recording sheet 18, the width sensor 43 (e.g., a switch of a contact point of the width sensor 43) detects positions to which the side plates 44 and 45 and the tail plate 46 are moved, and generates a several-bit signal in accordance with a detection result. When the recording sheet tray 49 is set in the image forming apparatus 100 (depicted in FIG. 2), the width sensor 43 is electrically connected to the image forming apparatus 100. Thus, the width sensor 43 sends the detection result as information about the size (e.g., width) of the recording sheet 18 to the arithmetic device. The arithmetic device determines the width of the recording sheet 18 based on the information about the size of the recording sheet 18 sent by the width sensor 43.

FIG. 13 is a perspective view of a recording sheet tray 49A as a modification example of the recording sheet tray 49 depicted in FIG. 12. As illustrated in FIG. 13, the recording sheet tray 49A includes a dial 47 and/or a size display window 48. The other elements of the recording sheet tray 49A are common to the recording sheet tray 49 (depicted in FIG. 12).

A user operates the dial 47 to move the side plates 44 and 45 and the tail plate 46 in accordance with a size and a feed direction of a recording sheet 18. The size display window 48 displays the size and feed direction of the recording sheet 18.

When the user moves the dial 47 to a reference position corresponding to the size and feed direction of the recording sheet 18, the width sensor 43 detects positions to which the side plates 44 and 45 and the tail plate 46 are moved, and generates a several-bit signal in accordance with a detection result. When the recording sheet tray 49A is set in the image forming apparatus 100 (depicted in FIG. 2), the width sensor 43 is electrically connected to the image forming apparatus 100. Thus, the width sensor 43 sends the detection result as information about the size (e.g., width) of the recording sheet 18 to the arithmetic device. The arithmetic device determines the width of the recording sheet 18 based on the information about the size of the recording sheet 18 sent by the width sensor 43.

The arithmetic device determines amounts of corrections of an excitation time and a torque of the driving motor 12 (depicted in FIG. 9) and a correction time, based on the measured thickness and width of the recording sheet 18.

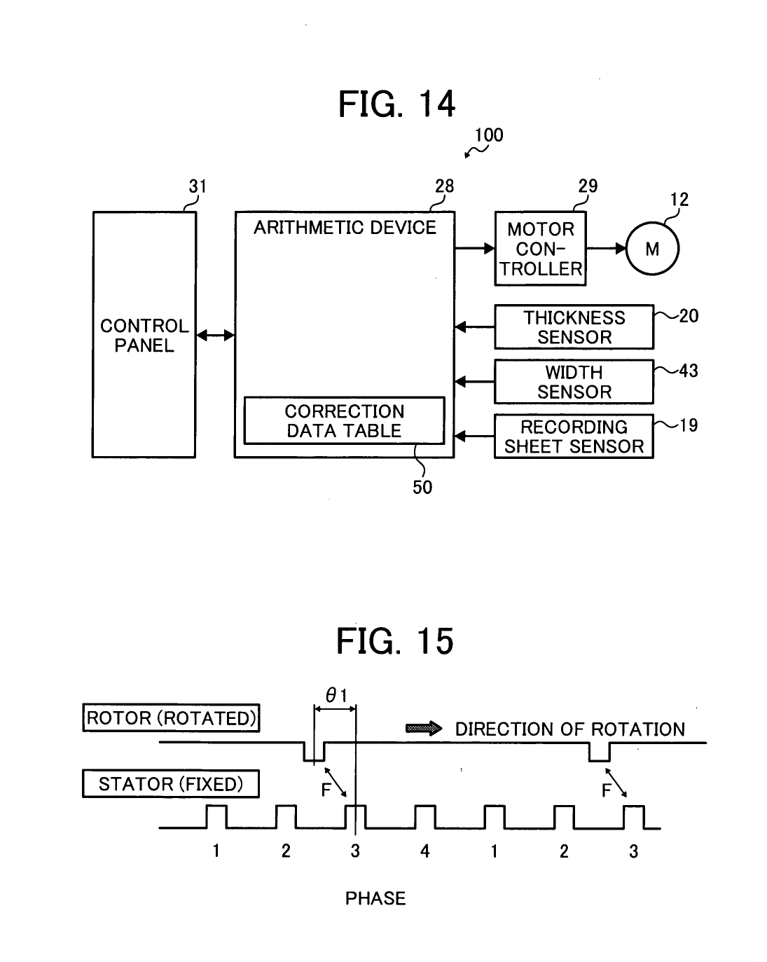

The thickness and width of the recording sheet 18 may be detected by a method other than the above-described methods. FIG. 14 illustrates yet another example method for detecting the thickness and width of the recording sheet 18. FIG. 14 is a block diagram of the image forming apparatus 100. The image forming apparatus 100 further includes a control panel 31, an arithmetic device 28, and/or a motor controller 29. The arithmetic device 28 includes a correction data table 50. The arithmetic device 28 and the motor controller 29 serve as a motor control device.

The user may input data about type and size of a recording sheet 18 set in the recording sheet tray 49 (depicted in FIG. 2) by using the control panel 31. The input data is sent to the arithmetic device 28 serving as a timer-controller. In this case, the thickness sensor 20 and the width sensor 43 are not used or provided. The arithmetic device 28 uses the input data sent from the control panel 31 instead of information about the thickness and width of the recording sheet 18 provided by the thickness sensor 20 and the width sensor 43, respectively.

The recording sheet sensor 19 includes a transmission type sensor, a reflection type sensor, and/or a micro switch. The recording sheet sensor 19 detects a leading edge of a recording sheet 18 fed by the registration roller pair 16 (depicted in FIG. 9), and generates a detection signal. The arithmetic device 28 receives and uses the detection signal as information to determine a time at which the recording sheet 18 reaches the second transfer roller 15 and the second transfer counter roller 14 (depicted in FIG. 9) and start and finish times at which corrections of an excitation time and a torque of the driving motor 12 are started and finished, respectively.

When the leading edge of the recording sheet 18 is near the second transfer roller 15 and the second transfer counter roller 14, the arithmetic device 28 controls the driving motor 12 based on determination data (e.g., data about amounts of the corrections of the excitation time and the torque of the driving motor 12 and correction times). Namely, the arithmetic device 28 corrects the exictation time and the torque of the driving motor 12 to prevent a change in the rotation speed of the intermediate transfer belt 9 (depicted in FIG. 9) caused by a transient change in a load torque applied to the intermediate transfer belt 9.

For example, the arithmetic device 28 serves as a controller for controlling the corrections of the excitation time and the torque of the driving motor 12 to cope with the transient change in the load torque applied to the intermediate transfer belt 9, so as to rotate the intermediate transfer belt 9 at a constant speed. The arithmetic device 28, the recording sheet sensor 19, the width sensor 43, and the thickness sensor 20 may serve as a motor control device for controlling the driving motor 12. The arithmetic device 28 controls the driving motor 12 based on information about the recording sheet 18 provided by the recording sheet sensor 19, the width sensor 43, and/or the thickness sensor 20. Further, the arithmetic device 28 drives the plunger magnet 25 depicted in FIG. 11.

The following describes two example methods for correcting the excitation time and the torque of the driving motor 12. In a first example method, the arithmetic device 28 changes an excitation phase time of the driving motor 12 based on detection results provided by the thickness sensor 20 for detecting a thickness of a recording sheet 18, the width sensor 43 for detecting a width of the recording sheet 18, and the recording sheet sensor 19 for detecting a conveyance time of the recording sheet 18. A load torque and a generation torque of the driving motor 12 are balanced so as to prevent a change in the rotation speed of the intermediate transfer belt 9.

In a second example method, the arithmetic device 28 changes both an excitation phase switch time and a driving current (e.g., torque) of the driving motor 12 based on detection results provided by the thickness sensor 20 for detecting a thickness of a recording sheet 18, the width sensor 43 for detecting a width of the recording sheet 18, and the recording sheet sensor 19 for detecting a conveyance time of the recording sheet 18. A load torque and a generation torque of the driving motor 12 are balanced so as to prevent a change in the rotation speed of the intermediate transfer belt 9.

FIG. 15 is a plane view of a stator and a rotor of the driving motor 12 (depicted in FIG. 9). The driving motor 12 functions as a two-phase stepping motor. A stepping motor is excited by a two-phase excitation method, a one-two-phase excitation method, or a micro step driving method, for example. In the one-two-phase excitation method, a stator phase of the two-phase stepping motor is driven and excited from phase 1 to phase 4 as from phase 1, phases 1 and 2, phase 2, phases 2 and 3, phase 3, phases 3 and 4, phase 4, phases 1 and 4, to phase 1 in this order. Accordingly, the rotor moves from left to right in FIG. 15.

FIG. 15 illustrates a moment at which phase 3 of the stator phase is excited. The rotor and the stator pull each other with a force F and are balanced with each other. Rotation or movement of the rotor is delayed from a mechanical center position of phase 3 of the stator by a phase angle θ1. The delay indicates a mechanical delay of the rotor from an electrical driving time of the stator phase. A generation torque of the stepping motor matches with a load torque externally applied at a position delayed by the phase angle θ1 and the stepping motor rotates.

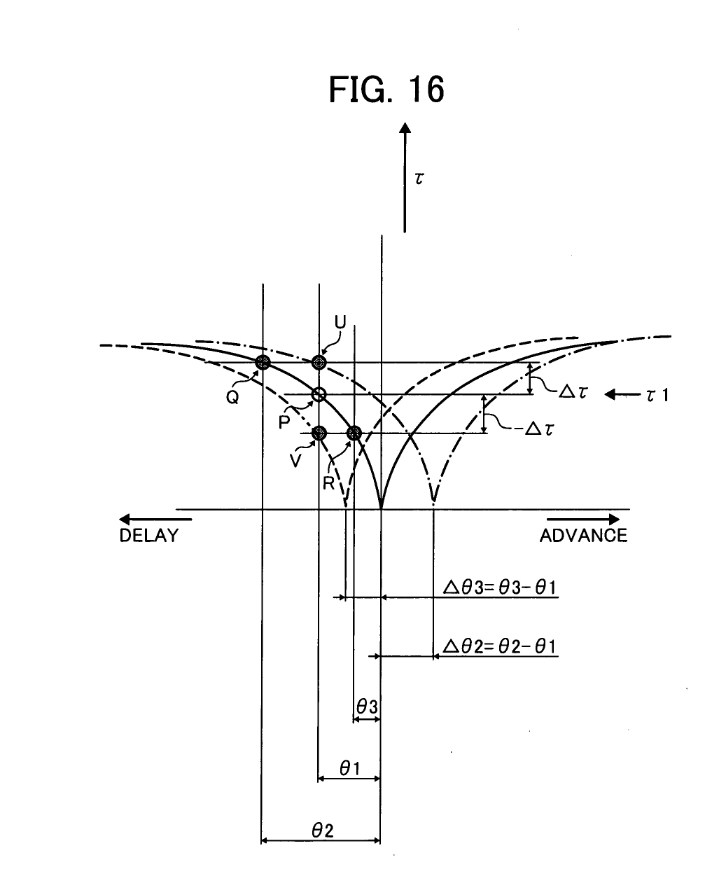

FIG. 16 illustrates the first example method for correcting an excitation time of the driving motor 12 (depicted in FIG. 2). The arithmetic device 28 (depicted in FIG. 14) corrects a phase switch time for switching the excitation time of the driving motor 12 between delay and advance directions to change a generation torque of the driving motor 12 to a position balanced with respect to a transient change in a load torque. Thus, the mechanical delay of the rotor from the stator is unchanged to prevent a change in the rotation speed of the intermediate transfer belt 9 (depicted in FIG. 2). As a result, yellow, magenta, cyan, and black toner images formed on the photoconductors 1, 2, 3, and 4 (depicted in FIG. 2), respectively, are transferred onto the intermediate transfer belt 9 without being shifted from each other.

In FIG. 16, a center of a horizontal axis represents phase 3 of excitation phases of the stator. Namely, the center of the horizontal axis represents a mechanical center of excitation phases. An area on the left side of the mechanical center represents a delay phase angle. An area on the right side of the mechanical center represents an advance phase angle. A vertical axis represents a generation torque of the driving motor 12 (depicted in FIG. 2). Curves represent torque curves generated when the driving motor 12 is driven with a driving current i1. When the rotor is positioned at the mechanical center, the generation torque is weakest. As the phase angle of the rotor becomes greater from the mechanical center toward right and left on the horizontal axis, the generation torque becomes greater. However, when the phase angle of the rotor exceeds a certain angle (not shown), the generation torque of the driving motor 12 sharply decreases due to a characteristic of a stepping motor.

When a load torque τ1 is applied, a generation torque and a load torque of the driving motor 12 are balanced at a point P at which rotation of the rotor of the driving motor 12 is delayed by a phase delay angle 01 from an excitation phase (e.g., phase 3). When the load torque increases from the load torque τ1 by a load torque increase Δτ, the generation torque and the load torque of the driving motor 12 are balanced at a point Q at which rotation of the rotor of the driving motor 12 is delayed by a phase delay angle θ2 from phase 3, when no correction control is performed to the driving motor 12. Namely, a balance point, at which the generation torque and the load torque of the driving motor 12 are balanced, moves from the point P to the point Q. Accordingly, the phase delay angle of the rotor changes from the phase delay angle θ1 to the phase delay angle θ2. A difference (e.g., a correction phase angle Δθ2) between the phase delay angles θ1 and θ2 delays a rotation speed of the rotor. The correction phase angle Δθ2 is obtained by an equation (1) below.

Δθ2=θ2−θ1 (1)

As described above, when a point at which phase angles of the rotor and the stator are balanced changes from the point P to the point Q, the rotation speed of the rotor changes. Accordingly, the rotation speed of the intermediate transfer belt 9 (depicted in FIG. 2) changes, resulting in image shift or color shift in which yellow, magenta, cyan, and black toner images formed on the photoconductors 1, 2, 3, and 4, respectively, are transferred onto the intermediate transfer belt 9 in a state in which the yellow, magenta, cyan, and black toner images are shifted from each other.

When the load torque increases by the load torque increase Δτ, the generation torque and the load torque of the driving motor 12 are balanced at the point Q. Therefore, the arithmetic device 28 (depicted in FIG. 14) changes a balance point, at which the generation torque and the load torque of the driving motor 12 are balanced, from the point Q to a point U to maintain the phase delay angle θ1.

Since the phase delay angle θ2 is greater than the phase delay angle θ1, the correction phase angle Δθ2 changed by the increased load torque and obtained by subtracting the phase delay angle θ1 from the phase delay angle θ2 is plus. When the arithmetic device 28 advances the excitation time of the driving motor 12 by the correction phase angle Δθ2 in an advance direction (e.g., when a curve indicated by alternate long and short dashed lines matches with a curve indicated by solid line), the generation torque and the load torque of the driving motor 12 are balanced at a position which is delayed by the phase delay angle θ1 and at which the generation torque and the load torque of the driving motor 12 are balanced before the load torque is generated. Thus, the correction phase angle Δθ2 is obtained by subtracting the phase delay angle θ1 from the phase delay angle θ2 and corresponds to a phase angle for moving the balance point from the point Q to the point U delayed by the phase delay angle θ1.

When the load torque increase Δτ generates transiently, the arithmetic device 28 advances the excitation time of the stator by the correction phase angle Δθ2 in the advance direction at a proper time, so that the generation torque and the load torque of the driving motor 12 are balanced at the point U. Namely, the phase delay angle matches with the initial phase delay angle θ1, and the rotation speed of the rotor does not change. When the driving motor 12 is a stepping motor, the correction phase angle Δθ2 is converted into time, and the arithmetic device 28 performs phase switch of the stator based on the converted time so as to increase the rotation speed of the driving motor 12. Even when the driving motor 12 is a DC (direct-current) motor or an ultrasonic motor, the arithmetic device 28 may perform similar phase switch of the stator so as to maintain the rotation speed of the driving motor 12 unchanged.

When the load torque decreases by an amount (e.g., a load torque decrease −Δτ equivalent to the load torque increase Δτ, and the balance point changes from the point P to a point R, the generation torque and the load torque of the driving motor 12 are balanced at the point R. A correction phase angle Δθ3 moves the balance point from the point R to a point V corresponding to the phase delay angle θ1, and is obtained by an equation (2) below.

Δθ3=Θ3−θ1 (2)

Since the phase delay angle θ1 is greater than a phase delay angle θ3, the correction phase angle Δθ3 is minus. When the arithmetic device 28 delays the excitation time of the driving motor 12 by the correction phase angle Δθ3 in a delay direction, the generation torque and the load torque of the driving motor 12 are balanced at the point V. A phase delay angle of the rotor matches with the initial phase delay angle θ1, preventing a change in the rotation speed of the intermediate transfer belt 9.

As described above, the torque generated by the driving motor 12 may be effectively used to prevent the change in the rotation speed of the intermediate transfer belt 9 caused by a transient change in the load torque applied to the intermediate transfer belt 9. Thus, changing the excitation time of the driving motor 12 may balance the generation torque and the load torque of the driving motor 12 without increasing power consumption of the driving motor 12. As a result, the image forming apparatus 100 (depicted in FIG. 2) may provide a high-quality image without increasing costs of the driving motor 12.

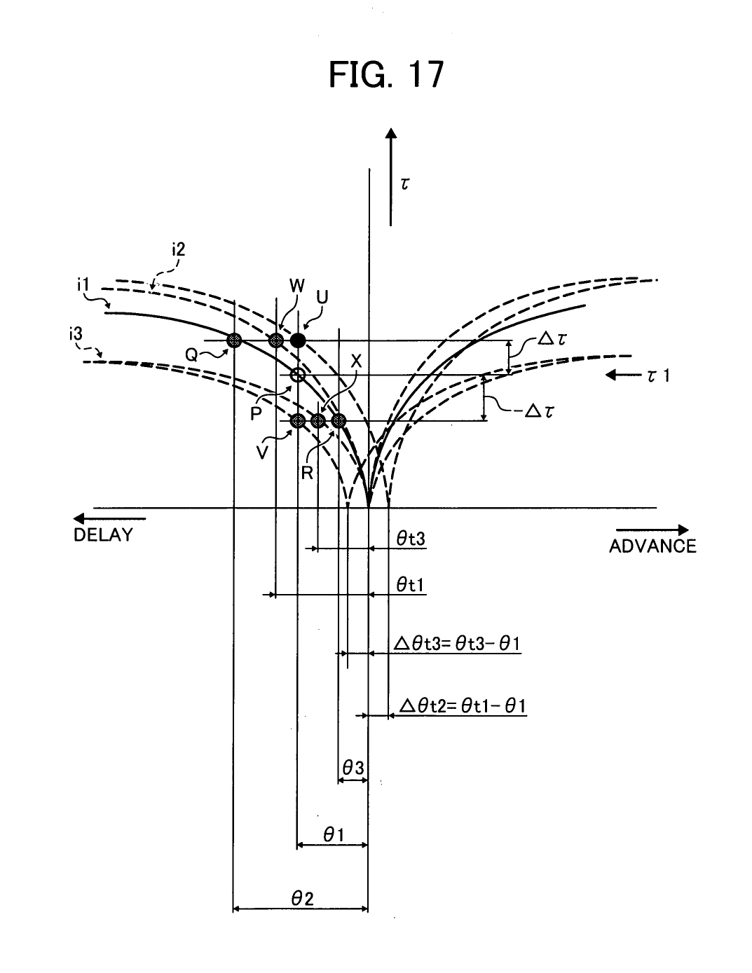

FIG. 17 illustrates the second example method for correcting an excitation time and a torque of the driving motor 12 (depicted in FIG. 2). The second example method corrects both the excitation time and the torque of the driving motor 12 to prevent a change in the rotation speed of the intermediate transfer belt 9 (depicted in FIG. 2) and thereby prevent image shift or color shift generated in yellow, magenta, cyan, and black toner images transferred on the intermediate transfer belt 9.

FIG. 17 is a graph illustrating a correction of a torque performed by correcting a driving current of the driving motor 12 and the correction of the excitation time of the driving motor 12 illustrated in FIG. 16. The driving motor 12 rotates at the point P having the load torque τ1 and the phase delay angle θ1 of the rotor.

When a load torque increases from the load torque τ1 by the load torque increase Δτ, a balance point, at which a generation torque and a load torque of the driving motor 12 are balanced, moves from the point P to the point Q, when no correction control is performed to the driving motor 12. When the load torque decreases from the load torque τ1 by the load torque decrease −Δτ, the balance point moves from the point P to the point R.

When the point at which phase angles of the rotor and the stator are balanced changes, the rotation speed of the rotor changes. Accordingly, the rotation speed of the intermediate transfer belt 9 changes, causing image shift or color shift.

When the load torque increases by the load torque increase Δτ, the generation torque and the load torque of the driving motor 12 are balanced at the point Q having the phase delay angle θ2. Therefore, the correction phase angle Δθ2 is obtained by an equation (3) below.

Δθ2=θ2−θ1 (3)

The phase delay angle θ2 corresponds to the phase angle for moving the balance point from the point Q to the point U.

The correction phase angle Δθ2 corresponds to the load torque increase Δτ transiently increased. When the driving current i1 for driving the driving motor 12 is increased to a driving current i2, the generation torque of the driving motor 12 increases. Accordingly, the balance point, at which the generation torque and the load torque of the driving motor 12 are balanced, moves from the point Q to a point W. The increased generation torque changes the phase delay angle from the phase delay angle θ2 to a phase delay angle θt1. When the balance point moves from the point W to the point U by correcting the excitation time of the driving motor 12, a correction phase angle Δθt2 is obtained by an equation (4) below.

Δθt2=θt1−θ1 (4)

Thus, the phase delay angle θ2 in the second example method may be smaller than the phase delay angle θ2 in the first example method.

As described above, the driving current of the driving motor 12 changes from the driving current i1 to the driving current i2, and the excitation time of the driving motor 12 is corrected with the smaller correction phase angle Δθt2. The balance point moves from the point Q to the point U at which the generation torque and the load torque of the driving motor 12 are balanced, and the phase delay angle of the rotor matches with the initial phase delay angle θ1. Thus, the rotation speed of the rotor does not change, preventing a change in the rotation speed of the intermediate transfer belt 9.

The second example method properly corrects both the driving current of the driving motor 12 and the excitation time of the stator. Namely, the second example method corrects the phase delay angle and the excitation time of the driving motor 12 with the small torque and the smaller correction phase angle Δθt2.

When the load torque decreases by the load torque decrease −Δτ and thereby the balance point moves from the point P to the point R, rotation of the rotor of the driving motor 12 is delayed by the phase delay angle θ3 from phase 3. The correction phase angle Δθ3 is obtained by an equation (5) below.

Δθ3=θ3−θ1 (5)

The phase delay angle θ3 corresponds to the phase angle for moving the balance point from the point R to the point V.

When the driving current i1 for driving the driving motor 12 is decreased to a driving current i3, the generation torque of the driving motor 12 decreases. Accordingly, the balance point, at which the generation torque and the load torque of the driving motor 12 are balanced, moves from the point R to a point X. The decreased generation torque changes the phase delay angle from the phase delay angle θ3 to a correction phase angle θt3. When the balance point moves from the point X to the point V by correcting the excitation time of the driving motor 12, a correction phase angle Δθt3 is obtained by an equation (6) below.

Δθt3=θt3−θ1 (6)

Since the correction phase angle Δθt3 is minus, the arithmetic device 28 corrects the correction phase angle by the correction phase angle Δθt3 in a delay direction. Further, the arithmetic device 28 corrects the torque of the driving motor 12 so that the generation torque and the load torque of the driving motor 12 are balanced at the point V. A phase delay angle of the rotor matches with the initial phase delay angle θ1, preventing a change in the rotation speed of the intermediate transfer belt 9.

As described above, the arithmetic device 28 properly corrects the excitation time and the torque of the driving motor 12 when the transient change in the load torque generates, preventing the change in the rotation speed of the intermediate transfer belt 9.

In the second example method, combination of the corrections of the excitation time and the torque (e.g., a driving current) of the driving motor 12 may cope with a greater torque change with smaller power consumption than in a method for correcting the generation torque of the driving motor 12, providing fine corrections when the load torque is substantially changed.

As illustrated in FIG. 9, a recording sheet 18 is conveyed while yellow, magenta, cyan, and black toner images superimposed on the intermediate transfer belt 9 are transferred onto the recording sheet 18. When the recording sheet sensor 19 detects a trailing edge of the recording sheet 18, the arithmetic device 28 (depicted in FIG. 14) calculates a time at which the trailing edge of the recording sheet 18 reaches the nip formed between the second transfer roller 15 and the second transfer roller pair 14 and determines start and finish times for starting and finishing corrections of an excitation time and a torque of the driving motor 12. For example, when the trailing edge of the recording sheet 18 reaches a position near the second transfer roller 15 and the second transfer counter roller 14, the arithmetic device 28 controls the corrections (e.g., the corrections of the excitation time and the torque) of the driving motor 12 to cope with a transient change in a load torque so as to prevent a change in the rotation speed of the intermediate transfer belt 9. After the yellow, magenta, cyan, and black toner images are transferred onto the recording sheet 18, the recording sheet 18 bearing the toner images is conveyed to the fixing device 61 (depicted in FIG. 2). The fixing device 61 applies heat to the recording sheet 18 to melt and fix the toner images on the recording sheet 18. In the first and second example methods, the correction of the excitation time of the driving motor 12 is performed in the similar manner.

As illustrated in FIG. 14, the arithmetic device 28 calculates an amount of the correction of the excitation time, an amount of the correction of the torque, a correction start time, and a correction finish time of the driving motor 12 based on detection results provided by the thickness sensor 20, the width sensor 43, and the recording sheet sensor 19. The arithmetic device 28 causes the motor controller 29 to start controlling the driving motor 12. The arithmetic device 28 includes the correction data table 50 for storing data needed for the corrections, and uses the correction data table 50 to control the corrections for the driving motor 12.

When the thickness sensor 20 and the width sensor 43 are not provided, the user inputs data about type, size, and thickness of a recording sheet 18 placed on the recording sheet tray 49 (depicted in FIG. 2) by using the control panel 31. The arithmetic device 28 also serves as a timer-controller for calculating a time at which the recording sheet 18 passes through the nip formed between the second transfer roller 15 and the second transfer counter roller 14 (depicted in FIG. 9) and controlling the driving motor 12.

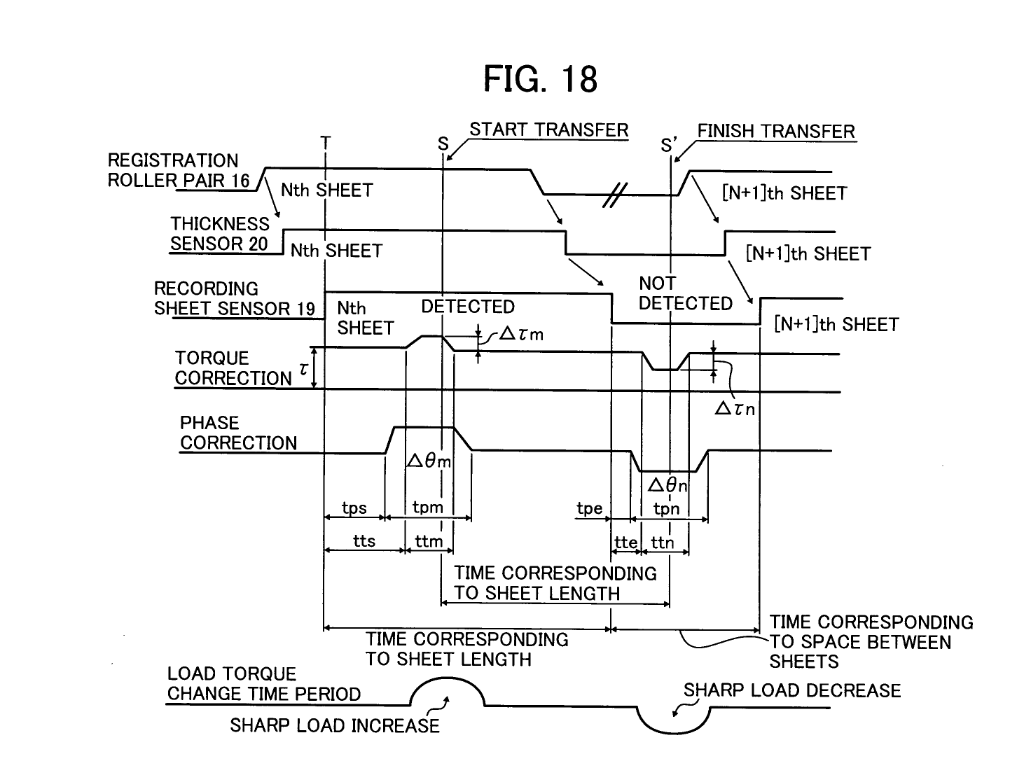

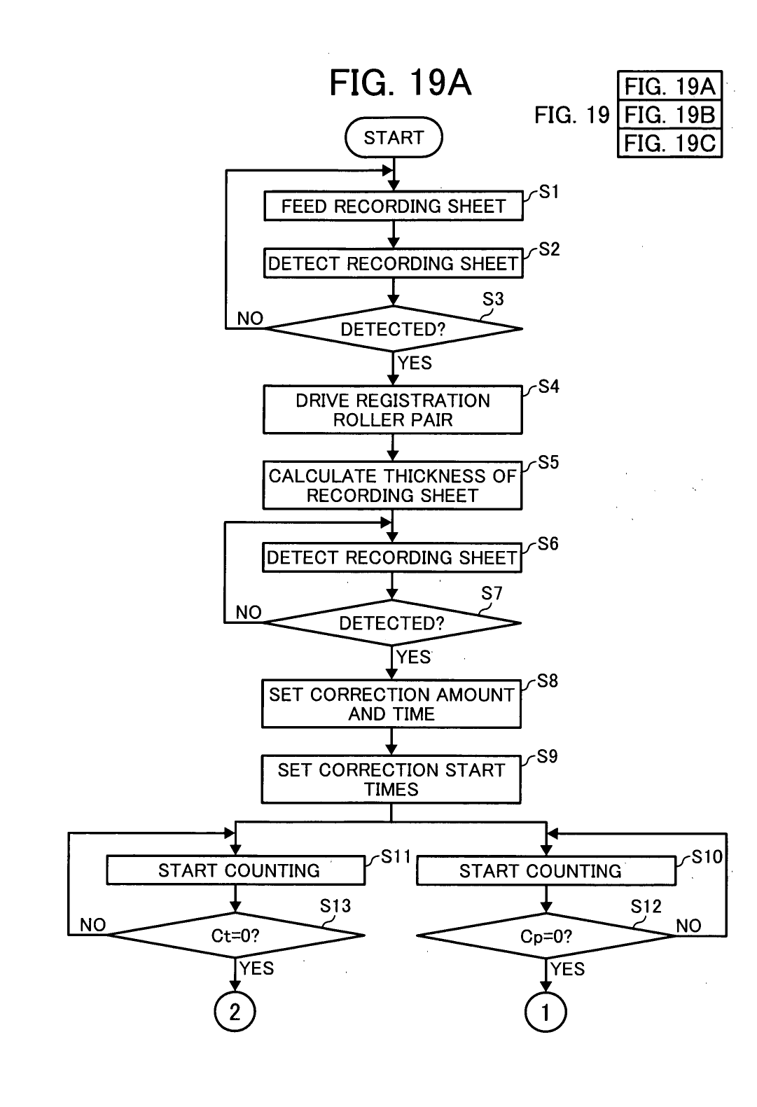

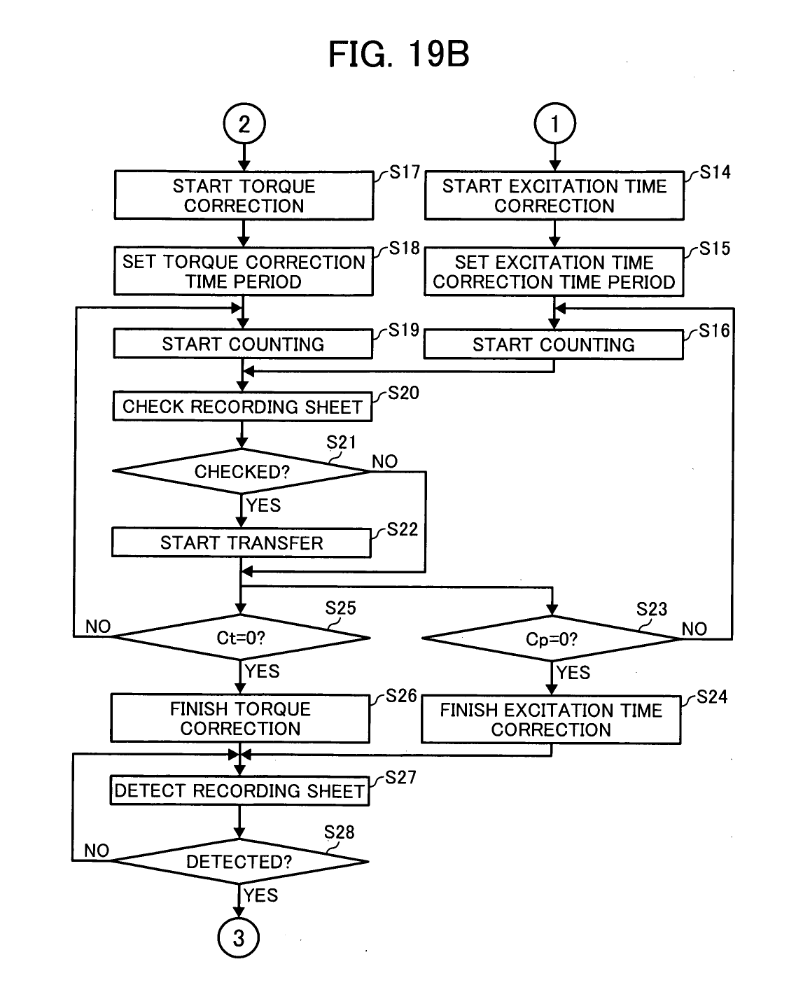

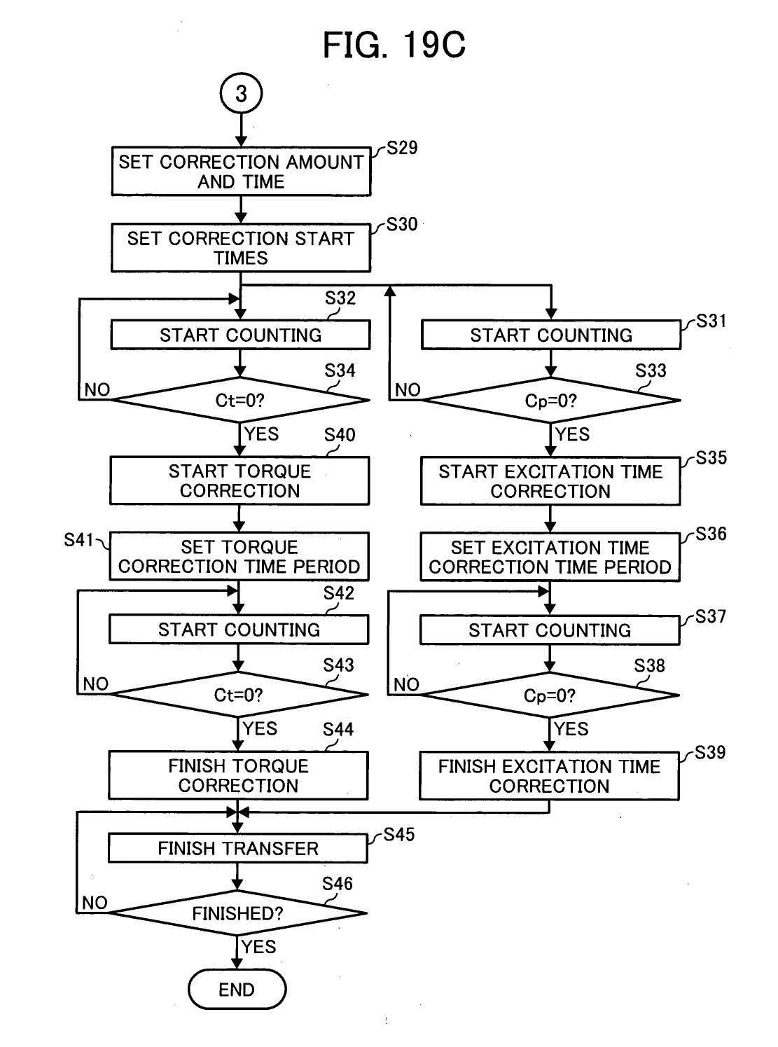

Referring to FIGS. 18, 19A, 19B, and 19C, the following describes operations of the second example method. FIG. 18 is a timing chart of controls performed in the second example method. FIGS. 19A, 19B, and 19C illustrate a flowchart of operations performed in the second example method.

The width sensor 43 (depicted in FIG. 12) provided on the recording sheet tray 49 (depicted in FIG. 12) detects a width of a recording sheet 18 and sends a detection result (e.g., width data) to the arithmetic device 28 (depicted in FIG. 14) in advance. As illustrated in FIG. 19A, in step S1, the recording sheet 18 is fed from the recording sheet tray 49 and enters a nip formed by the registration roller pair 16 (depicted in FIG. 9). The registration roller pair 16 aligns a leading edge of the recording sheet 18. In step S2, the insertion sensor 17 (depicted in FIG. 9) detects the recording sheet 18. In step S3, the arithmetic device 28 repeatedly checks whether or not the insertion sensor 17 has detected the recording sheet 18 based on a detection signal sent from the insertion sensor 17 until the insertion sensor 17 detects the recording sheet 18. If the insertion sensor 17 has detected the recording sheet 18 (e.g., if YES is selected in step S3), the arithmetic device 28 outputs a command to cause a clutch (not shown) to connect the registration roller pair 16 to a driving source (not shown) in step S4. Namely, the driving source drives the registration roller pair 16 via the clutch. Thus, the registration roller pair 16 starts rotating to feed the recording sheet 18.

In step S5, the thickness sensor 20 (depicted in FIG. 9) detects a thickness of the recording sheet 18 fed by the registration roller pair 16. The arithmetic device 28 calculates the thickness of the recording sheet 18 based on a detection signal sent by the thickness sensor 20. In step S6, the recording sheet sensor 19 (depicted in FIG. 9) detects the recording sheet 18. In step S7, the arithmetic device 28 repeatedly checks whether or not the recording sheet sensor 19 has detected the leading edge (e.g., a point T depicted in FIG. 18) of the recording sheet 18 based on a detection signal sent by the recording sheet sensor 19 until the recording sheet sensor 19 detects the leading edge of the recording sheet 18. If the recording sheet sensor 19 has detected the leading edge of the recording sheet 18 (e.g., if YES is selected in step S7), the arithmetic device 28 retrieves an amount of a transient change in a load torque from the correction data table 50 (depicted in FIG. 14) based on the thickness of the recording sheet 18 detected by the thickness sensor 20 and the width of the recording sheet 18 detected by the width sensor 43. The correction data table 50 stores a quantification table showing a relationship between the thickness and width of the recording sheet 18 and the amount of the transient change in the load torque of the driving motor 12 (depicted in FIG. 9). The arithmetic device 28 determines and sets necessary, proper correction amount and time of the driving motor 12 based on the amount of the transient change in the load torque in step S8. The correction amount includes a phase angle correction amount for an excitation time with respect to the leading edge of the recording sheet 18 and a torque correction amount. The correction amount and time determined and set by the arithmetic device 28 are shown below.
1) Excitation time correction amount Δθm (e.g., a phase angle correction amount for an excitation time with respect to the leading edge of the recording sheet 18)
2) Time allocation for the phase angle correction amount for the excitation time (e.g., through-up and through-down of a target value)
3) Excitation time correction start time tps and excitation time correction time period tpm
4) Torque correction amount Δτm with respect to the leading edge of the recording sheet 18
5) Time allocation for the torque correction amount (e.g., through-up and through-down of a target value)
6) Torque correction start time tts and torque correction time period ttm

The arithmetic device 28 sets the excitation time correction amount Δθm based on the amount of the transient change in the load torque while maintaining mechanical delay and advance between the rotor and the excitation phase of the stator. Further, the arithmetic device 28 performs through-up and through-down settings of target values so that through-up and through-down controls are gradually performed for target values of the corrections of the excitation time and the torque of the driving motor 12, respectively. Thus, the arithmetic device 28 sets the excitation time correction start time tps and the, torque correction start time tts before the transient change in the load torque generates. The arithmetic device 28 sets the excitation time correction time period tpm and the torque correction time period ttm so that the corrections of the excitation time and the torque are finished before the transient change in the load torque ends. The arithmetic device 28 sets the torque correction amount Δτm as a torque correction amount by which the transient change in the load torque is corrected. The excitation time correction start time tps and the torque correction start time tts are set near the time at which the transient change in the load torque generates.

In step S9, the arithmetic device 28 sets the torque correction start time tts and the excitation time correction start time tps to counters Ct and Cp, respectively. In step S10, the arithmetic device 28 causes the counter Cp to start counting backward for measuring the excitation time correction start time tps. In step S11, the arithmetic device 28 causes the counter Ct to start counting backward for measuring the torque correction start time tts. In step S12, the arithmetic device 28 determines whether or not the count counted by the counter Cp reaches 0. In step S13, the arithmetic device 28 determines whether or not the count counted by the counter Ct reaches 0. If the count does not reach 0 (e.g., if NO is selected in steps S12 and S13), steps S10 and S11 are repeated.

As illustrated in FIG. 19B, if the count reaches 0, that is, when a reference time period elapses (e.g., the excitation time correction start time tps passes) after the recording sheet sensor 19 detects the leading edge (e.g., the point T depicted in FIG. 18) of the recording sheet 18 and the leading edge of the recording sheet 18 reaches a position near and upstream from the nip formed between the second transfer roller 15 and the second transfer counter roller 14 in the recording sheet conveyance direction, the arithmetic device 28 starts driving control of the driving motor 12 via the motor controller 29 (depicted in FIG. 14) in step S14. Thus, the arithmetic device 28 starts a correction of an excitation time of the driving motor 12 and performs the correction based on the excitation time correction amount Δθm and the time allocation for the phase angle correction amount (e.g., through-up and through-down of a target value) which have been set. In step S15, the arithmetic device 28 sets the excitation time (e.g., phase) correction time period tpm of the driving motor 12 to the counter Cp. In step S16, the arithmetic device 28 causes the counter Cp to start counting backward for measuring the excitation time correction time period tpm.

If the count reaches 0, that is, when a reference time period elapses (e.g., the torque correction start time tts passes) after the recording sheet sensor 19 detects the leading edge (e.g., the point T depicted in FIG. 18) of the recording sheet 18 and the leading edge of the recording sheet 18 reaches a position near and upstream from the nip formed between the second transfer roller 15 and the second transfer counter roller 14 in the recording sheet conveyance direction, the arithmetic device 28 starts driving control of the driving motor 12 via the motor controller 29 in step S17. Thus, the arithmetic device 28 starts a correction of a torque of the driving motor 12 and performs the correction based on the torque correction amount Aim and the time allocation for the torque correction amount (e.g., through-up and through-down of a target value) which have been set. In step S18, the arithmetic device 28 sets the torque correction time period ttm of the driving motor 12 to the counter Ct. In step S19, the arithmetic device 28 causes the counter Ct to start counting backward for measuring the torque correction time period ttm.

In step S20, the arithmetic device 28 checks the recording sheet 18. In step S21, the arithmetic device 28 checks whether or not the leading edge of the recording sheet 18 reaches the nip formed between the second transfer roller 15 and the second transfer counter roller 14. If the leading edge of the recording sheet 18 reaches the nip (e.g., if YES is selected in step S21), the arithmetic device 28 causes a power source (not shown) to apply a transfer bias to the second transfer roller 15 to start a second transfer for transferring the yellow, magenta, cyan, and black toner images superimposed on the intermediate transfer belt 9 (depicted in FIG. 9) onto the recording sheet 18 in step S22. In step S23, the arithmetic device 28 determines whether or not the count of the counter Cp reaches 0. If the count does not reach 0 (e.g., if NO is selected in step S23, the arithmetic device 28 repeats step S16. If the count reaches 0 (e.g., if YES is selected in step S23), the arithmetic device 28 finishes driving control of the driving motor 12 via the motor driver 29 to finish the correction of the excitation time of the driving motor 12 in step S24. In step S25, the arithmetic device 28 determines whether or not the count of the counter Ct reaches 0. If the count does not reach 0 (e.g., if NO is selected in step S25), the arithmetic device 28 repeats step S19. If the count reaches 0 (e.g., if YES is selected in step S25), the arithmetic device 28 finishes driving control of the driving motor 12 via the motor driver 29 to finish the correction of the torque of the driving motor 12 in step S26.

In FIG. 18, the point T represents a position of the recording sheet sensor 19. A point S represents a position between axes of the second transfer roller 15 and the second transfer counter roller 14 (depicted in FIG. 9). In FIG. 6, the point S represents the leading edge of the recording sheet 18 and the point S′ represents the trailing edge of the recording sheet 18. A time period of a load torque change is generated on each of the points S and S′ and both sides of each of the points S and S′ near the points S and S′. Therefore, considering mechanical delay in response, the arithmetic device 28 starts the corrections of the excitation time and the torque of the driving motor 12 (depicted in FIG. 9) before the transient change in the load torque generates and finishes the corrections before the transient change in the load torque ends. The time period of the transient change in the load torque may vary depending on the thickness and width of the recording sheet 18. Therefore, the arithmetic device 28 sets amounts and start times of the corrections of the excitation time and the torque of the driving motor 12, which are suitable for the thickness of the recording sheet 18 measured by the thickness sensor 20 and the width of the recording sheet 18 determined in advance based on width data of the recording sheet 18 provided by the width sensor 43.

In step S27, the recording sheet sensor 19 detects the trailing edge of the recording sheet 18. In step S28, the arithmetic device 28 repeatedly checks whether or not the recording sheet sensor 19 has detected the trailing edge of the recording sheet 18 based on a detection signal sent from the recording sheet sensor 19 until the recording sheet sensor 19 detects the trailing edge of the recording sheet 18. If the recording sheet sensor 19 has detected the trailing edge of the recording sheet 18 (e.g., if YES is selected in step S28), the arithmetic device 28 retrieves an amount of a transient change in the load torque from the correction data table 50 based on the thickness of the recording sheet 18 detected by the thickness sensor 20 and the width of the recording sheet 18 detected in advance by the width sensor 43, as the arithmetic device 28 has retrieved the amount of the transient change in the load torque when the recording sheet sensor 19 has detected the leading edge of the recording sheet 18. The correction data table 50 stores a quantification table showing a relationship between the thickness and width of the recording sheet 18 and the amount of the transient change in the load torque of the driving motor 12.

As illustrated in FIG. 19C, the arithmetic device 28 determines and sets necessary, proper correction amount and time of the driving motor 12 based on the amount of the transient change in the load torque in step S29. The correction amount includes a phase angle correction amount for an excitation time with respect to the trailing edge of the recording sheet 18 and a torque correction amount. The correction amount and time determined and set by the arithmetic device 28 are shown below.
1) Excitation time correction amount Δθn (e.g., a phase angle correction amount for an excitation time with respect to the trailing edge of the recording sheet 18)
2) Time allocation for the phase angle correction amount for the excitation time (e.g., through-up and through-down of a target value)
3) Excitation time correction start time tpe and excitation time correction time period tpn
4) Torque correction amount Δτn with respect to the trailing edge of the recording sheet 18
5) Time allocation for the torque correction amount (e.g., through-up and through-down of a target value)
6) Torque correction start time tte and torque correction time period ttn

The arithmetic device 28 sets the excitation time correction amount Δθn based on the amount of the transient change in the load torque while maintaining mechanical delay and advance between the rotor and the excitation phase of the stator. Further, the arithmetic device 28 performs through-up and through-down settings of target values so that through-up and through-down controls are gradually performed for target values of the corrections of the excitation time and the torque of the driving motor 12, respectively. Thus, the arithmetic device 28 sets the excitation time correction start time tpe and the torque correction start time tte before the transient change in the load torque generates. The arithmetic device 28 sets the excitation time correction time period tpn and the torque correction time period ttn so that the corrections of the excitation time and the torque are finished before the transient change in the load torque ends. The arithmetic device 28 sets the torque correction amount Δτn as a torque correction amount by which the transient change in the load torque is corrected. The excitation time correction start time tpe and the torque correction start time tte are set near the time at which the transient change in the load torque generates.

In step S30, the arithmetic device 28 sets the torque correction start time tte and the excitation time correction start time tpe to the counters Ct and Cp, respectively. In step S31, the arithmetic device 28 causes the counter Cp to start counting backward for measuring the excitation time correction start time tpe. In step S32, the arithmetic device 28 causes the counter Ct to start counting backward for measuring the torque correction start time tte. In step S33, the arithmetic device 28 determines whether or not the count counted by the counter Cp reaches 0. In step S34, the arithmetic device 28 determines whether or not the count counted by the counter Ct reaches 0. If the count does not reach 0 (e.g., if NO is selected in steps S33 and S34), steps S31 and S32 are repeated. If the count reaches 0, that is, when a reference time period elapses (e.g., the excitation time correction start time tpe passes) after the recording sheet sensor 19 detects the trailing edge of the recording sheet 18 and the trailing edge of the recording sheet 18 reaches a position near and upstream from the nip formed between the second transfer roller 15 and the second transfer counter roller 14 in the recording sheet conveyance direction, the arithmetic device 28 starts driving control of the driving motor 12 via the motor controller 29 in step S35. Thus, the arithmetic device 28 starts a correction of an excitation time of the driving motor 12 and performs the correction based on the excitation time correction amount Δθn and the time allocation for the phase angle correction amount (e.g., through-up and through-down of a target value) which have been set. In step S36, the arithmetic device 28 sets the excitation time (e.g., phase) correction time period tpn of the driving motor 12 to the counter Cp. In step S37, the arithmetic device 28 causes the counter Cp to start counting backward for measuring the excitation time correction time period tpn. In step S38, the arithmetic device 28 determines whether or not the count counted by the counter Cp reaches 0. If the count does not reach 0 (e.g., if NO is selected in step S38), step S37 is repeated. If the count reaches 0 (e.g., if YES is selected in step S38), the arithmetic device 28 finishes driving control of the driving motor 12 via the motor driver 29 to finish the correction of the excitation time of the driving motor 12 in step S39.

If the count reaches 0 in step S34 (e.g., if YES is selected in step S34), that is, when a reference time period elapses (e.g., the torque correction start time tte passes) after the recording sheet sensor 19 detects the trailing edge of the recording sheet 18 and the trailing edge of the recording sheet 18 reaches a position near and upstream from the nip formed between the second transfer roller 15 and the second transfer counter roller 14 in the recording sheet conveyance direction, the arithmetic device 28 starts driving control of the driving motor 12 via the motor controller 29 in step S40. Thus, the arithmetic device 28 starts a correction of a torque of the driving motor 12 and performs the correction based on the torque correction amount Δτn and the time allocation for the torque correction amount (e.g., through-up and through-down of a target value) which have been set. In step S41, the arithmetic device 28 sets the torque correction time period ttn of the driving motor 12 to the counter Ct. In step S42, the arithmetic device 28 causes the counter Ct to start counting backward for measuring the torque correction time period ttn. In step S43, the arithmetic device 28 determines whether or not the count counted by the counter Ct reaches 0. If the count does not reach 0 (e.g., if NO is selected in step S43), step S42 is repeated. If the count reaches 0 (e.g., if YES is selected in step S43), the arithmetic device 28 finishes driving control of the driving motor 12 via the motor driver 29 to finish the correction of the torque of the driving motor 12 in step S44.

In step S45, the arithmetic device 28 causes the power source to stop applying a transfer bias to the second transfer roller 15 to finish the second transfer for transferring the yellow, magenta, cyan, and black toner images superimposed on the intermediate transfer belt 9 onto the recording sheet 18, when the recording sheet 18 has passed through the nip formed between the second transfer roller 15 and the second transfer counter roller 14. In step S46, the arithmetic device 28 checks whether or not the second transfer is finished. If second transfer is not finished (e.g., if NO is selected in step S46), step S45 is repeated.

Considering mechanical delay in response, the arithmetic device 28 starts the corrections of the excitation time and the torque of the driving motor 12 before the transient change in the load torque generates and finishes the corrections before the transient change in the load torque ends. The time period of the transient change in the load torque may vary depending on the thickness and width of the recording sheet 18. Therefore, the arithmetic device 28 sets amounts and start times of the corrections of the excitation time and the torque of the driving motor 12, which are suitable for the thickness of the recording sheet 18 measured by the thickness sensor 20 and the width of the recording sheet 18 determined in advance based on width data of the recording sheet 18 provided by the width sensor 43.

When the operations illustrated in FIGS. 19A, 19B, and 19C are repeated, the arithmetic device 28 may perform the corrections of the excitation time and the torque of the driving motor 12 suitable for the recording sheet 18 irrespective of the transient change in the load torque, preventing image shift or color shift.

According to the above-described embodiment and example methods, the driving motor 12 may be an ultrasonic motor or a DC motor and the arithmetic device 28 may perform the above-described corrections of the excitation time and the torque of the ultrasonic motor or the DC motor. Further, the arithmetic device 28 may perform the above-described corrections of the excitation time and the torque based on information about the thickness and width of the recording sheet 18 input by the user for each of the recording sheet trays 49 by using the control panel 31 instead of information about the thickness and width of the recording sheet 18 provided by the thickness sensor 20 and the width sensor 43, respectively.

As illustrated in FIG. 9, the arithmetic device 28 (depicted in FIG. 14), serving as a timer-controller, calculates a time at which a recording sheet 18, serving as a recording medium, passes through a nip formed between the second transfer roller 15 (e.g., a second transfer member) and the second transfer counter roller 14 (e.g., a counter member), serving as a pair of rotating members. The arithmetic device 28 controls the driving motor 12 for driving one or both of the second transfer roller 15 and the second transfer counter roller 14. Even when a transient change in a load torque applied to the intermediate transfer belt 9 generates when the recording sheet 18 passes through the nip formed between the second transfer roller 15 and the second transfer counter roller 14, the arithmetic device 28 performs corrections of an excitation time and a torque of the driving motor 12 near a time at which the transient change in the load torque generates. The corrections of the excitation time and the torque of the driving motor 12 may prevent a change in a rotation speed of the intermediate transfer belt 9 caused by the transient change in the load torque and resulting in image shift or color shift. Namely, the change in the rotation speed of the intermediate transfer belt 9 may be prevented with no extra element added to the image forming apparatus 100, resulting in decreased manufacturing costs of the image forming apparatus 100.

The arithmetic device 28 starts the corrections of the excitation time and the torque of the driving motor 12 before the transient change in the load torque applied to the intermediate transfer belt 9 generates due to the recording sheet 18 passing through the nip formed between the second transfer roller 15 and the second transfer counter roller 14. Thus, the arithmetic device 28 may prevent a correction delay caused by a structural factor and may provide fine corrections when the load torque changes.

The arithmetic device 28 starts the corrections of the excitation time and the torque of the driving motor 12 before the transient change in the load torque applied to the intermediate transfer belt 9 generates due to the recording sheet 18 passing through the nip formed between the second transfer roller 15 and the second transfer counter roller 14. The arithmetic device 28 finishes the corrections before the transient change in the load torque ends. Thus, the arithmetic device 28 may prevent a delay in correction completion resulting from the correction delay caused by the structural factor.

When the corrections of the excitation time and the torque of the driving motor 12 are performed at one time when the transient change in the load torque generates, the driving motor 12 may cause synchronization error and noise. However, according to the above-described example embodiment and example methods, the arithmetic device 28 performs through-up and through-down controls gradually for target values of the corrections of the excitation time and the torque of the driving motor 12, respectively. For example, the arithmetic device 28 performs the corrections with proper time allocation and through-up and through-down controls. Thus, the arithmetic device 28 may reduce the synchronization error and noise and may provide fine corrections when the load torque changes.

The arithmetic device 28 performs the corrections of the excitation time and the torque of the driving motor 12 when a reference time period elapses after a command for operating the registration roller pair 16, serving as a recording medium conveyer, is output. For example, the arithmetic device 28 starts the corrections to correct a transient change in the load torque in synchronism with feeding of a recording sheet 18 performed by the registration roller pair 16. Thus, the arithmetic device 28 may perform the corrections with an increased precision.

The recording sheet sensor 19, serving as a recording medium detector, detects a recording sheet 18 conveyed on the recording sheet conveyance path. The arithmetic device 28 performs the corrections of the excitation time and the torque of the driving motor 12 when a reference time period elapses after the recording sheet sensor 19 outputs a detection signal. For example, the arithmetic device 28 starts the corrections to correct a transient change in the load torque based on a detection result output by the recording sheet sensor 19 provided on the recording sheet conveyance path. Thus, the arithmetic device 28 may perform the corrections with an increased precision.

A load torque change amount varies depending on the thickness of a recording sheet 18. Therefore, when a uniform correction condition is used for the corrections of the excitation time and the torque of the driving motor 12, the uniform correction condition may not correct a transient change in the load torque having the varied load torque change amount. However, according to the above-described embodiment and example methods, the arithmetic device 28 determines amounts of the corrections of the excitation time and the torque of the driving motor 12 based on a detection result output by the thickness sensor 20, serving as a thickness detector for detecting the thickness of the recording sheet 18 conveyed on the recording sheet conveyance path. For example, the arithmetic device 28 performs the corrections corresponding to the thickness of the recording sheet 18 provided by the thickness sensor 20. Thus, the arithmetic device 28 may perform the fine corrections corresponding to the varied load torque change amount.

The load torque change amount also varies depending on the width of the recording sheet 18. Therefore, when a uniform correction condition is used for the corrections of the excitation time and the torque of the driving motor 12, the uniform correction condition may not correct a transient change in the load torque having the varied load torque change amount. However, according to the above-described embodiment and example methods, the arithmetic device 28 determines amounts of the corrections of the excitation time and the torque of the driving motor 12 based on a detection result output by the width sensor 43, serving as a width detector for detecting the width of the recording sheet 18 conveyed on the recording sheet conveyance path. For example, the arithmetic device 28 performs the corrections corresponding to the width of the recording sheet 18 provided by the width sensor 43. Thus, the arithmetic device 28 may perform the fine corrections corresponding to the varied load torque change amount.

The load torque change time period varies depending on the thickness and width of the recording sheet 18. Therefore, when a uniform correction condition is used for the corrections of the excitation time and the torque of the driving motor 12, the uniform correction condition may not correct a transient change in the load torque having the varied load torque change time period. However, according to the above-described embodiment and example methods, the arithmetic device 28 determines start and finish of a correction time period for correcting the excitation time and the torque of the driving motor 12 based on detection results output by the thickness sensor 20 and the width sensor 43. For example, the arithmetic device 28 sets a start time and a time period of the corrections corresponding to the thickness and width of the recording sheet 18 provided by the thickness sensor 20 and the width sensor 43, respectively. Thus, the arithmetic device 28 may perform the fine corrections corresponding to the varied load torque change time period. Alternatively, the arithmetic device 43 may determine start and finish of the corrections based on one of the detection results provided by the thickness sensor 20 and the width sensor 43.

The arithmetic device 28 retrieves correction data (e.g., start and finish times and amounts of the corrections of the excitation time and the torque of the driving motor 12) from the correction data table 50 prepared in advance. Thus, the arithmetic device 28 may perform the corrections at an increased speed.

The driving motor 12 may be a stepping motor widespread on the market. Thus, high-reliability corrections may be provided at low costs. Alternatively, the driving motor 12 may be an ultrasonic motor. Thus, fine, high-resolution corrections may be provided. Further, the driving motor 12 may be a DC motor, such as a brushless DC motor, widespread on the market. Thus, a high-reliability structure may be provided at low costs.

The arithmetic device 28 may set the thickness and width of the recording sheet 18 based on information about the thickness and width of the recording sheet 18 input in advance by the user for each of the recording sheet trays 49 by using the control panel 31. Thus, the corrections may be performed without the thickness sensor 20 at low costs.

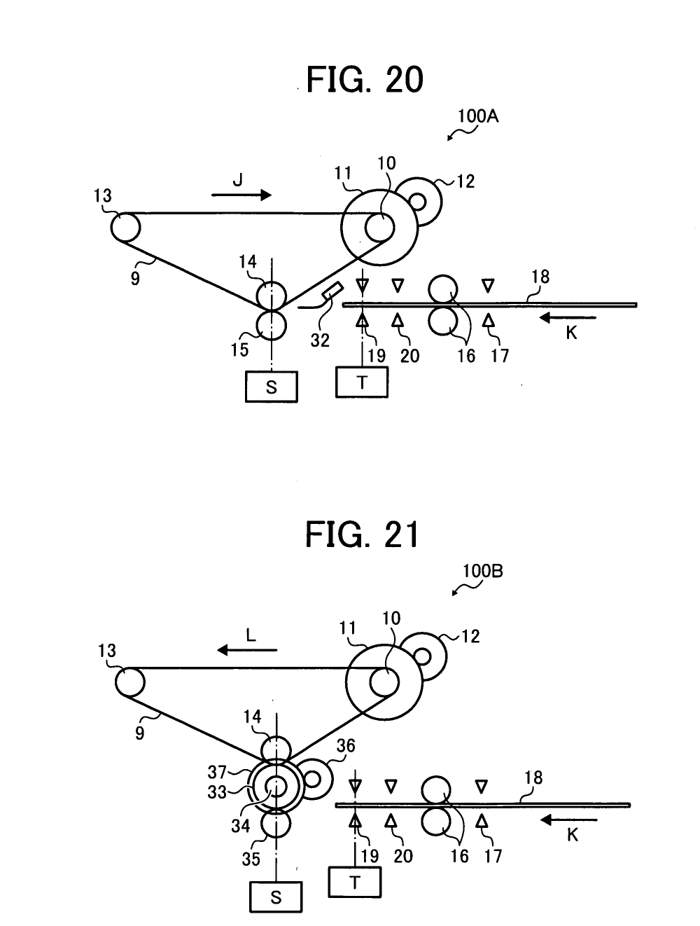

Referring to FIG. 20, the following describes an image forming apparatus 100A according to another example embodiment. The image forming apparatus 100A includes a heating device 32. The other elements of the image forming apparatus 100A are common to the image forming apparatus 100 depicted in FIG. 9.

The heating device 32 heats a recording sheet 18. At the nip formed between the second transfer roller 15 and the second transfer counter roller 14, transfer and fixing of toner images are performed simultaneously. For example, at the nip, yellow, magenta, cyan, and black toner images superimposed on the intermediate transfer belt 9 are transferred onto the heated recording sheet 18 and fixed on the recording sheet 18.

When the recording sheet 18 is conveyed to the nip, a transient change in a load torque applied to the intermediate transfer belt 9 generates and changes the rotation speed of the intermediate transfer belt 9, resulting in image shift or color shift. To address these problems, the image forming apparatus 100A performs the corrections of the excitation time and the torque of the driving motor 12 common to the image forming apparatus 100. Thus, the image forming apparatus 100A may reduce the change in the rotation speed of the intermediate transfer belt 9. Accordingly, image shift or color shift may be prevented.

Referring to FIG. 21, the following describes an image forming apparatus 100B according to yet another example embodiment. The image forming apparatus 100B includes a transfer-fixing roller 33, a heater 34, a third transfer counter roller 35, a second transfer driving motor 36, and/or a reduction gear 37. The other elements of the image forming apparatus 100B are common to the image forming apparatus 100 depicted in FIG. 9.

The intermediate transfer belt 9 rotates in a direction of rotation L opposite to the direction of rotation J of the intermediate transfer belt 9 depicted in FIG. 9. The transfer-fixing roller 33 and the second transfer counter roller 14 serve as a transferor. The transfer-fixing roller 33 serves as a second transfer member and a fixing member. The heater 34 is provided inside the transfer-fixing roller 33 and heats the transfer-fixing roller 33. The third transfer counter roller 35, serves as a counter member and applies pressure to the transfer-fixing roller 33 to perform third transfer. The second transfer counter roller 14 opposes the transfer-fixing roller 33 via the intermediate transfer belt 9 to cause the intermediate transfer belt 9 to pressingly contact the transfer-fixing roller 33. The third transfer counter roller 35 pressingly contacts the transfer-fixing roller 33. The second transfer driving motor 36 drives the transfer-fixing roller 33 via the reduction gear 37 to rotate at a circumferential speed common to the intermediate transfer belt 9.

When a recording sheet 18 passes through a nip formed between the transfer-fixing roller 33 and the third transfer counter roller 35, transfer and fixing of toner images are performed simultaneously. For example, yellow, magenta, cyan, and black toner images superimposed on the intermediate transfer belt 9 are transferred onto the transfer-fixing roller 33. The transferred toner images are further transferred onto the recording sheet 18 and are fixed on the recording sheet 18.

The transfer-fixing roller 33 and the third transfer counter roller 35 serve as a pair of rotating members. When the recording sheet 18 is conveyed to the nip formed between the transfer-fixing roller 33 and the third transfer counter roller 35, a transient change in a load torque generates and changes a rotation speed of the transfer-fixing roller 33, resulting in image shift or color shift. To address these problems, the corrections of the excitation time and the torque performed in the image forming apparatus 100 are performed on the driving motor 12 for driving the intermediate transfer belt 9 via the reduction gear 11 and the second transfer driving motor 36 for driving the transfer-fixing roller 33 via the reduction gear 37. Thus, a change in the rotation speed of the transfer-fixing roller 33 may be reduced, preventing image shift or color shift. The driving motor 12 and the second transfer driving motor 36 may be integrated into a single shared driver. The single shared driver may provide effects common to the effects provided by the driving motor 12 and the second transfer driving motor 36 individually provided.

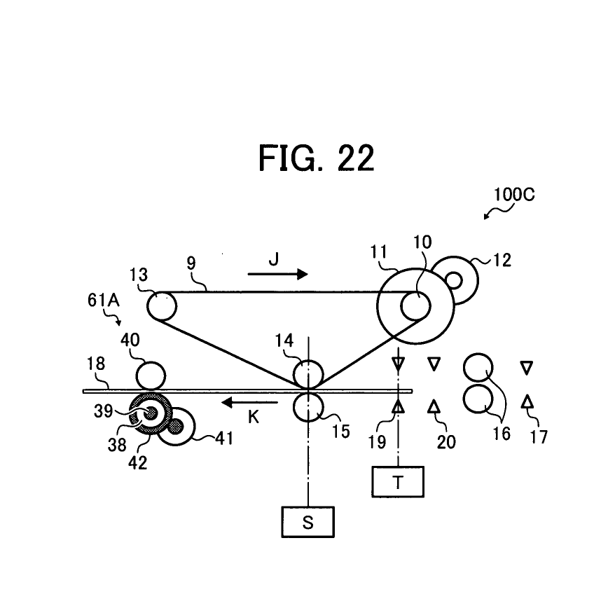

Referring to FIG. 22, the following describes an image forming apparatus 100C according to yet another example embodiment. The image forming apparatus 100C includes a fixing unit 61A. The fixing unit 61A includes a fixing roller 38, a heater 39, a fixing counter roller 40, a fixing motor 41, and/or a reduction gear 42. The other elements of the image forming apparatus 100C are common to the image forming apparatus 100 depicted in FIG. 9.

The fixing unit 61A serves as a fixing device. The heater 39 is provided inside the fixing roller 38 and heats the fixing roller 38. The fixing roller 38 and the fixing counter roller 40 serve as a roller pair or a pair of rotating members. The fixing counter roller 40 pressingly contacts the fixing roller 38 and applies pressure to the fixing roller 38. The fixing motor 41, serving as a driving motor, drives the fixing roller 38 via the reduction gear 42.

A recording sheet 18 bearing yellow, magenta, cyan, and black toner images transferred from the intermediate transfer belt 9 is conveyed to a nip formed between the fixing roller 38 and the fixing counter roller 40. When the recording sheet 18 passes through the nip, the fixing roller 38 and the fixing counter roller 40 fix the toner images on the recording sheet 18. When the recording sheet 18 enters the nip, a transient change in a load torque generates and changes a conveyance speed of the recording sheet 18. When the recording sheet 18 nipped by the fixing roller 38 and the fixing counter roller 40 is also nipped by the second transfer roller 15 and the second transfer counter roller 14, the change in the conveyance speed of the recording sheet 18 caused at the nip formed between the fixing roller 38 and the fixing counter roller 40 is transmitted to the second transfer roller 15 and the second transfer counter roller 14. Accordingly, the second transfer roller 15 may not transfer yellow, magenta, cyan, and black toner images from the intermediate transfer belt 9 onto the recording sheet 18 at a constant speed, resulting in image shift or color shift.

To address these problems, the corrections of the excitation time and the torque performed on the driving motor 12 in the image forming apparatus 100 are applied to the fixing motor 41 for driving the fixing roller 38 via the reduction gear 42. Thus, the change in the conveyance speed of the recording sheet 18 may be reduced, preventing image shift or color shift.

The driving motor 12 and the fixing motor 41 may be integrated into a single shared driver. The single shared driver may provide effects common to the effects provided by the driving motor 12 and the fixing motor 41 individually provided.

As illustrated in FIG. 21, the corrections of the excitation time and the torque are performed on the second transfer driving motor 36 for driving one roller (e.g., the transfer-fixing roller 33) of the roller pair (e.g., a pair of rotating members). However, the second transfer driving motor 36 may be configured to drive two rollers (e.g., the transfer-fixing roller 33 and the third transfer counter roller 35) of the roller pair.

Similarly, as illustrated in FIG. 22, the corrections of the excitation time and the torque are performed on the fixing motor 41 for driving one roller (e.g., the fixing roller 38) of the roller pair (e.g., a pair of rotating members). However, the fixing motor 41 may be configured to drive two rollers (e.g., the fixing roller 38 and the fixing counter roller 40) of the roller pair.

When a recording medium (e.g., the recording sheet 18 depicted in FIG. 9) is conveyed to a pair of rotating members (e.g., a pair of the transfer-fixing roller 33 and the third transfer counter roller 35 depicted in FIG. 21, a pair of the fixing roller 38 and the fixing counter roller 40 depicted in FIG. 22, or a pair of the second transfer roller 15, serving as a second transfer member, and the second transfer counter roller 14, serving as a counter member depicted in FIG. 9), a load torque applied to a motor (e.g., the driving motor 12 depicted in FIG. 9, the second transfer driving motor 36 depicted in FIG. 21, or the fixing motor 41 depicted in FIG. 22) may be transiently changed in accordance with thickness and/or width of the recording medium. However, according to the above-described example embodiments, a generation torque and a load torque of the motor may be balanced without increasing power consumption of the motor substantially.

When the load torque is changed in accordance with the thickness and/or width of the recording medium, a fine correction is performed on the generation torque of the motor to balance the generation torque and the load torque of the motor. Thus, deterioration of image quality due to image shift or color shift may be prevented and a high-quality image may be formed.

The present invention has been described above with reference to specific example embodiments. Nonetheless, the present invention is not limited to the details of example embodiments described above, but various modifications and improvements are possible without departing from the spirit and scope of the present invention. It is therefore to be understood that within the scope of the associated claims, the present invention may be practiced otherwise than as specifically described herein. For example, elements and/or features of different illustrative example embodiments may be combined with each other and/or substituted for each other within the scope of the present invention.

What is claimed is:

1. A motor control device, comprising:
a pair of rotating members to nip and convey a recording medium;
a driving motor to drive at least one rotating member of the pair of rotating members; and
a timer-controller to calculate a time at which the recording medium passes through a nip formed by the pair of rotating members and control the driving motor by correcting an excitation time of the driving motor near the time at which the recording medium passes through the nip formed by the pair of rotating members.

2. The motor control device according to claim 1,
wherein the timer-controller further corrects a torque of the driving motor.

3. An image forming apparatus, comprising:
an image carrier to carry a toner image;
an intermediate transfer member to carry the toner image transferred from the image carrier;
a driving motor to drive the intermediate transfer member;
a recording medium conveyer to convey a recording medium;
a transferor to transfer the toner image carried by the intermediate transfer member onto the recording medium conveyed by the recording medium conveyer, the transferor comprising:
a second transfer member to pressingly contact the intermediate transfer member; and
a counter member to oppose the second transfer member via the intermediate transfer member and press the intermediate transfer member toward the second transfer member; and
a timer-controller to calculate a time at which the recording medium contacts the second transfer member and control the driving motor by correcting one of an excitation time and both an excitation time and a torque of the driving motor near the time at which the recording medium contacts the second transfer member.

4. The image forming apparatus according to claim 3, further comprising:
a heating device provided near and upstream from the transferor in a recording medium conveyance direction, the heating device heating the recording medium.

5. The image forming apparatus according to claim 3, further comprising:
a second driving motor to drive the second transfer member; and
a second counter member to oppose the second transfer member and press the recording medium conveyed by the recording medium conveyer toward the second transfer member,
wherein the second transfer member includes a fixing member to fix the toner image on the recording medium, and the timer-controller further controls the second driving motor by correcting one of an excitation time and both an excitation time and a torque of the second driving motor.

6. The image forming apparatus according to claim 3,
wherein the timer-controller starts correction before the recording medium contacting the second transfer member generates a transient change in a load torque of the transferor.

7. The image forming apparatus according to claim 6,
wherein the timer-controller gradually performs through-up and through-down controls for target values of the correction of the excitation time and the torque of the driving motor, respectively.

8. The image forming apparatus according to claim 3,
wherein the timer-controller starts correction before the recording medium contacting the second transfer member generates a transient change in a load torque of the transferor, and finishes correction before the transient change in the load torque ends.

9. The image forming apparatus according to claim 3,
wherein the recording medium conveyer includes a registration roller pair, and the timer-controller performs the correction when a reference time period elapses after output of a command for operating the registration roller pair.

10. The image forming apparatus according to claim 3, further comprising:
a recording medium detector to detect the recording medium on a conveyance path on which the recoding medium is conveyed by the recording medium conveyer,
wherein the timer-controller performs correction when a reference time period elapses after the recording medium detector outputs a detection signal.

11. The image forming apparatus according to claim 3, further comprising:
a thickness detector to detect a thickness of the recording medium on a conveyance path on which the recoding medium is conveyed by the recording medium conveyer,
wherein the timer-controller determines an amount of correction based on a detection result provided by the thickness detector.

12. The image forming apparatus according to claim 3, further comprising:
a width detector to detect a width of the recording medium on a conveyance path on which the recoding medium is conveyed by the recording medium conveyer,
wherein the timer-controller determines an amount of correction based on a detection result provided by the width detector.

13. The image forming apparatus according to claim 3, further comprising:
a thickness detector to detect a thickness of the recording medium on a conveyance path on which the recoding medium is conveyed by the recording medium conveyer; and
a width detector to detect a width of the recording medium on a conveyance path on which the recoding medium is conveyed by the recording medium conveyer,
wherein the timer-controller starts and finishes correction based on a detection result provided by at least one of the thickness detector and the width detector.

14. The image forming apparatus according to claim 3, further comprising:
a recording medium container to contain the recording medium; and
a control panel operated by a user to input thickness and width information corresponding to the recording medium contained in the recording medium container,
wherein the timer-controller performs correction based on the thickness and width information input by the user.

15. The image forming apparatus according to claim 3,
wherein the timer-controller performs correction by using a table for storing data needed for the correction.

16. The image forming apparatus according to claim 3,
wherein the driving motor includes one of a stepping motor, an ultrasonic motor, and a direct-current motor.

17. An image forming apparatus, comprising:
an image carrier to carry a toner image;
an intermediate transfer member to carry the toner image transferred from the image carrier;
a driving motor to drive the intermediate transfer member;
a recording medium conveyer to convey a recording medium;
a transferor to transfer the toner image carried by the intermediate transfer member onto the recording medium conveyed by the recording medium conveyer;
a fixing device provided downstream from the transferor in a recording medium conveyance direction to fix the toner image on the recording medium, the fixing device comprising:
a roller pair to nip the recording medium bearing the toner image; and
a fixing motor to drive at least one roller of the roller pair; and
a timer-controller to calculate a time at which the recording medium passes through a nip formed by the roller pair and control the fixing motor, the timer-controller correcting one of an excitation time and both an excitation time and a torque of the fixing motor near the time at which the recording medium passes through the nip formed by the roller pair.

18. The image forming apparatus according to claim 17,
wherein the timer-controller starts correction before the recording medium passing through the nip formed by the roller pair generates a transient change in a load torque of the transferor.

19. The image forming apparatus according to claim 17,
wherein the timer-controller starts correction before the recording medium passing through the nip formed by the roller pair generates a transient change in a load torque of the transferor, and finishes the correction before the transient change in the load torque ends.
